(19) United States
(12) Patent Application Publication
(10) Pub. No.: US 2017/0055262 A1
(43) Pub. Date: Feb. 23, 2017

(54) BASE STATION APPARATUS, PROCESSING METHOD, TERMINAL DEVICE, AND PROCESSING APPARATUS

(71) Applicant: SHARP KABUSHIKI KAISHA, Sakai City, Osaka (JP)

(72) Inventors: Osamu NAKAMURA, Sakai City (JP); Shiro WAKAHARA, Sakai City (JP); Hiromichi TOMEBA, Sakai City (JP); Jungo GOTO, Sakai City (JP); Yasuhiro HAMAGUCHI, Sakai City (JP)

(21) Appl. No.: 15/305,144

(22) PCT Filed: Apr. 21, 2015
(86) PCT No.: PCT/JP2015/062156

§ 371 Date: Oct. 19, 2016

(30) Foreign Application Priority Data
Apr. 24, 2014 (JP) 2014-089957

(51) Int. Cl. H04W 72/04

(52) U.S. Cl. CPC H04W 72/0453; H04W 88/02

(57) ABSTRACT

More efficient control and stably establishing, securing, and continuing communication using unlicensed bands, in use of the unlicensed bands. A base station apparatus of the present invention is a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used, and the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

### TECHNICAL FIELD

The present invention relates to a base station apparatus, a processing method, a terminal device, and a processing apparatus.

### BACKGROUND ART

The evolution of radio access methods and radio networks of cellular mobile communication (hereinafter, referred to as “Long Term Evolution (LTE)”, or “Evolved Universal Terrestrial Radio Access (EUTRA)”.) has been studied in the 3rd Generation Partnership Project (3GPP). In LTE, an Orthogonal Frequency Division Multiplexing (OFDM) scheme, which is multi-carrier transmission, is used as a communication scheme of wireless communication (downlink) from a base station apparatus (also referred to as an evolved Node B, or eNB) to a terminal device (also referred to as a mobile station apparatus, User Equipment, or UE). Further, a Single-Carrier Frequency Division Multiple Access scheme (SC-FDMA) is used as a communication scheme of wireless communication (uplink) from the terminal device to the base station apparatus.

Further, radio access methods and radio networks which realize faster data communication using a frequency band which is wider than LTE (hereinafter, referred to as “Long Term Evolution-Advanced (LTE-A)” or “Advanced Evolved Universal Terrestrial Radio Access (A-EUTRA)”) have been studied in the 3GPP. LTE-A is required to have backward compatibility with LTE, in other words, in such a manner that the base station apparatus of LTE-A performs wireless communication with the terminal devices of both LTE-A and LTE at the same time, and the terminal device of LTE-A performs wireless communication with the base station apparatuses of both LTE-A and LTE, and it is considered that LTE-A uses the same channel structure as in LTE.

In LTE-A, a technique of aggregating the frequency bands (hereinafter, referred to as “Component Carrier: CC”) of the same channel structure as in LTE and using the aggregated frequency bands as a single frequency band (a wide frequency band) has been studied (also referred to as a frequency band aggregation scheme: Spectrum aggregation, Carrier aggregation, Frequency aggregation, or the like). Specifically, in the communication using a frequency band aggregation scheme of Frequency Division Duplex (FDD), a downlink channel is transmitted for each downlink component carrier, and an uplink channel is transmitted for each uplink component carrier. In other words, the frequency band aggregation scheme is a technique in which the base station apparatus and a plurality of terminal devices transmit and receive a plurality of pieces of data and a plurality of pieces of control information at the same time, by using a plurality of channels, or a plurality of component carriers, in the uplink and downlink.

In communication using the frequency band aggregation scheme, it has been proposed that the base station apparatus sets a downlink component carrier (DLCC) and a uplink component carrier (ULCC) to be used for communication to the terminal device by using a Radio Resource Control signal (RRC signal) or the like, and notifies of an activation command indicating the downlink component carrier to be used for downlink communication, from the set DLCC, by using a Physical Downlink Control Channel (PDCCH), Medium Access Control (MAC) Control Element (CE), or the like. (NPL 1)

### CITATION LIST

### Non Patent Literature

NPL 1: “Open issues on component carrier activation and deactivation”, 3GPP TSG RAN WG2 Meeting #69, R2-101082, Feb. 22-26, 2010.

### SUMMARY OF INVENTION

### Technical Problem

However, the lack of communication resources due to an increase in the capacity of transmission data and the number of subscribers in recent years becomes remarkable. For example, since image data and video data are increasingly sent and received by the user and the image quality itself has advanced, the amount of data to be transmitted and received is remarkably increased, and thus the communication resources that a single user uses are inevitably increased. On the other hand, if focusing on the number of subscribers of LTE and LTE-A, the number of users who change a communication scheme from W-CDMA and GSM (registered trademark) to LTE and LTE-A is extremely increased in recent years. The lack of communication resources due to an increase in the capacity of the communication data and the number of users as described above is serious. Therefore, the use of unlicensed band has attracted attention in recent years.

A communication company (sometimes referred to as operators or carriers) provides commercial communication to subscribers by exclusively using frequency bands which are officially allowed. For example, a base station allocates some frequency bands that can be exclusively used, as communication resources to respective subscribers (terminals). If a plurality of terminals are present, the base station is able to provide communication to the plurality of terminals at the same time, by allocating some different frequency bands to the plurality of terminals as communication resources, respectively. The terminal communicates other terminals by using the allocated communication resource, through the base station. The frequency band which is allowed to be exclusively used is sometimes referred to as a frequency band that can be exclusively used, or simply an exclusive communication band, or a licensed band. In other words, a frequency band, that an allowed communication company is able to exclusively use to provide communication to a plurality of terminals, is simply referred to as a frequency band that can be exclusively used, a dedicated frequency band, or a licensed band. In this specification, this is referred to as a licensed band, hereinafter. In contrast, a frequency band which is not allowed to be exclusively used, and cannot be exclusively used but can temporarily be used may be referred to as a frequency band that cannot be exclusively used, simply a non-dedicated frequency band, or an unlicensed band. In this specification, this is referred to as an unlicensed band, hereinafter. For example, the unlicensed band corresponds to a frequency band which is used in a wireless LAN or the like, and is normally used in, for example, connection with a personal computer or a printer according to the specification of IEEE802.11n. Note that the wireless LAN standard of course includes other standards such as IEEE 802.11a, b, g, ac, or the like.

However, since an unlicensed band is originally a frequency band that cannot be exclusively used, it has various restrictions. Not only that, a normal terminal is not generally assumed to use the unlicensed band in communication with a base station, and actually is not able to use the unlicensed band in communication, without having one of or both specific usage and control means for the unlicensed band. Similarly, it is difficult for the base station to use the unlicensed band in communication with a terminal device.

The present invention has been made in view of the above, and an object is to propose control which is more efficient and is capable of stably establishing, securing, and continuing communication using unlicensed bands, in use of the unlicensed bands.

### Solution to Problem

(1) In order to achieve the above object, the present invention has the following means. In other words, a base station apparatus according to the present invention is a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used, in which the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

(2) The control information includes an activate instruction.

(3) When notifying the terminal device of the control information by using the frequency band that cannot be exclusively used, the base station apparatus notifies the terminal device of the control information by using an identifier that is used for a function that is used for the frequency band that can be exclusively used and is not used for the frequency band that cannot be exclusively used.

(4) The function that is used for the frequency band that can be exclusively used and is not used for the frequency band that cannot be exclusively used is semi-static scheduling.

(5) The identifier is SPS C-RNTI.

(6) A processing method by a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used, in which the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

(7) A terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used, in which the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.

(8) A processing method by a terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used, in which the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.

(9) A processing apparatus which is mounted to a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used, in which the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

(10) A processing apparatus which is mounted to a terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used, in which the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.

### Advantageous Effects of Invention

An object is to propose control which is more efficient and is capable of stably establishing, securing, and continuing communication using unlicensed bands, in use of the unlicensed bands.

It is possible to achieve faster communication, while stably establishing, securing, and continuing the communication using the unlicensed bands, as more efficient or more flexible control, in use of the unlicensed bands.

### BRIEF DESCRIPTION OF DRAWINGS

FIG. 1 is a conceptual diagram of a wireless communication system according to the present invention.

FIG. 2 is a schematic block diagram illustrating a configuration of a base station apparatus 3 of the present invention.

FIG. 3 is a schematic block diagram illustrating a configuration of a mobile station apparatus 1 of the present invention.

FIG. 4 is a diagram illustrating a combination of frequency bands, which is used as a cell of an unlicensed band of the present invention.

FIG. 5 is a diagram illustrating a combination of frequency bands, which is used as a cell of an unlicensed band of the present invention.

FIG. 6 is a diagram illustrating notification and control of control information of an unlicensed band of the present invention.

FIG. 7 is a diagram illustrating notification and control of control information of an unlicensed band of the present invention.

FIG. 8 is a diagram illustrating notification and control of control information of an unlicensed band of the present invention.

FIG. 9 is a diagram illustrating notification and control of control information of an unlicensed band of the present invention.

FIG. 10 is a diagram illustrating notification and control of control information of an unlicensed band of the present invention.

FIG. 11 is a diagram illustrating notification and control of control information of an unlicensed band of the present invention.

FIG. 12 is a diagram illustrating notification and control of control information of an unlicensed band of the present invention.

FIG. 13 is a diagram illustrating control of an unlicensed band of the present invention.

FIG. 14 is a diagram illustrating control of an unlicensed band of the present invention.

FIG. 15 is a diagram illustrating control of an unlicensed band of the present invention.

FIG. 16 is a diagram illustrating control of an unlicensed band of the present invention.

FIG. 17 is a diagram illustrating control of an unlicensed band of the present invention.

FIG. 18 is a diagram illustrating notification and control of control information of an unlicensed band of the present invention.

FIG. 19 is a diagram illustrating notification and control of control information of an unlicensed band of the present invention.

FIG. 20 is a diagram illustrating notification and control of control information of an unlicensed band of the present invention.

### DESCRIPTION OF EMBODIMENTS

### First Embodiment

Hereinafter, a first embodiment of the present invention will be described with reference to the drawings. In the present embodiment, a setting method and a control method of the unlicensed band will be described. Hereinafter, applying a communication scheme which is applied to the cells of the licensed band, for example, LTE-A, to the unlicensed band, and using the unlicensed band for communication between the base station apparatus and the terminal device are referred to as being used as the cells of the unlicensed band. For example, applying the same communication scheme (for example, LTE-A) as the communication scheme which is applied to the cells of the licensed band, to the frequency band of the unlicensed band, and using the unlicensed band for communication with the base station are referred to as using the frequency band as the cells of the unlicensed band. Subsequently, the base station, the terminal, an access point or the like will be described.

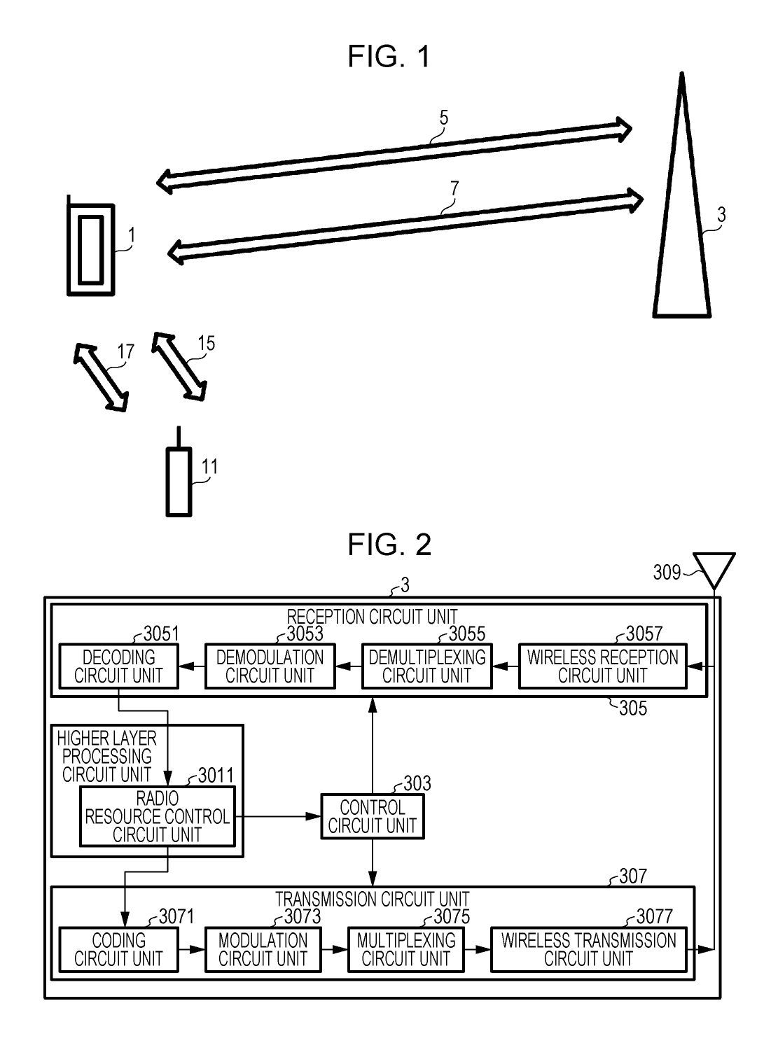

FIG. 1 is a conceptual diagram of a wireless communication system according to a first embodiment of the present invention. In FIG. 1, the wireless communication system includes a terminal device 1 and a base station apparatus 3.

Incidentally, in this embodiment, the terminal device 1 is described as a mobile phone, but may be a communication circuit parts of another device. For example, the terminal device may be a communication device that communicates with the base station apparatus 3 which is connected to or built into a personal computer. The terminal device may be a communication device that communicates with the base station apparatus 3 which is connected to or built into a vehicle or a car navigation device. These may also be referred to as user equipment collectively. Further, the terminal device may be a communication device that communicates with the base station apparatus 3 which is connected to or built into a refrigerator or an air conditioner. Only the terminal device 1 is depicted as the terminal device in FIG. 1 for simplification of explanation, but it is possible to include a plurality of terminal devices, in other words, at least one terminal device in the wireless communication system. Similarly, with respect to the base station apparatus 3, not only the base station apparatus 3 but also a plurality of base station apparatus are included, in other words, at least one base station apparatus are included in the wireless communication system. FIG. 1 typically depicts only one base station 3. Further, the base station apparatus 3 may be a base station that controls a macro cell capable of providing communication services to a wide area, may be a base station of a small cell which is capable of providing communications only to a very small area, or may be a Closed Subscriber Group (CSG) cell base station that is designed to provide communication services to a particular user. In other words, for example, the base station apparatus 3 may be a base station in home, or may be a home base station.

In FIG. 1, the base station apparatus 3 communicates with the terminal device 1, by using the licensed band. The communication is performed by using either a serving cell 5 or a serving cell 7, or both the serving cell 5 and the serving cell 7, as the cells of the licensed band. Here, as the serving cell, the serving cells which are actually used in communication with the base station apparatus 3 are simply described as cells. In other words, the serving cell 5 is simply described as a cell 5, and the serving cell 7 is simply described as a cell 7. The cell 7 is used as a primary cell (described below), and the cell 5 is used as a secondary cell (described below). Here, the cell 5 and the cell 7 may be different frequency bands. The cell is a frequency band that the base station apparatus 3 uses in the communication with the terminal device 1 or another terminal device, or is a single unit that is used when the base station apparatus 3 manages the communication with the terminal device 1 using the frequency band.

Each cell may be configured with frequency bands which are used in uplink communication and frequency bands which are used in downlink communication respectively, or may be configured only with frequency bands which are used in downlink communication. These frequency bands, that is, frequency bands constituting a cell (or frequency bands which are used as a cell) are referred to as component carriers, and in particular, the frequency bands which are used in uplink communication are referred to as uplink component carriers (hereinafter, ULCC), and the frequency bands which are used in downlink communication are referred to as downlink component carriers (hereinafter, DLCC). For example, the cell 7 which is a primary cell is configured with the ULCC 7 and the DLCC 7, and the cell 5 which is a secondary cell is configured with the ULCC 5 and the DLCC 5.

The base station apparatus 3 sets a single cell out of the cell 5 and the cell 7 which are set, as a primary cell. The primary cell may be a cell which is used in an initial access for establishing wireless connection, in a state where wireless connection between the terminal device 1 and the base station apparatus 3 is not established. In the present embodiment, it is assumed that the cell 7 is set as a primary cell. On the other hand, a cell which is not the primary cell is referred to as a secondary cell. In FIG. 1, the secondary cell is the cell 5.

Further, the number of cell to be used is two, and a single primary cell and a single secondary cell are used. However the number of cells to be used may be three or more, but since the number of primary cells is only one as described above, two or more secondary cells are configured. Alternatively, it may be configured by using only the cell 7, that is, using only the primary cell, and without using the secondary cell. In other words, only one primary cell is used, or one primary cell and at least one secondary cell may be used. In other words, it may be configured such that the base station apparatus 3 and the terminal device 1 can communicate by using the frequency bands of one or more licensed bands, as the frequency bands to be used. In FIG. 1, as described above, a description is given on a configuration of using one primary cell and one secondary cell.

In addition, in this specification, the cells, in particular, the secondary cell can be configured only with the DLCC, without having the ULCC, as described above. For example, a cell 9, not illustrated, is used instead of the cell 5 or along with the cell 5, and the cell 9 may be configured only with the DLCC 9, without having the ULCC. In other words, the secondary cell may include at least DLCC. In a case of using the cell 7 and the cell 5 in FIG. 1 as described above, in other words, a description will be given with a case where both the primary cell and the secondary cell include the ULCC and the DLCC as an example.

An access point 11 of a wireless LAN is present in the vicinity of the terminal device 1 in FIG. 1. The access point 11 is capable of communicating with other devices, for example, a personal computer or a printer (not illustrated) by Carrier Sense Multiple Access with Collision Avoidance (CSMA/CA) communication, according to, for example, IEEE802.11n, functions as a wireless router, and is also capable of communicating with the terminal device 1.

The access point 11 is connected to the Internet by a wired connection, through for example, an optical fiber. In addition, without being limited to a wired connection, the access point may be connected to the Internet through a wireless connection such as a Mobile WiMAX (IEEE802.16e). Furthermore, the access point 11 is capable of communicating with, for example, the terminal device 1 by using selectively or both the frequency bands 15 and 17. The access point 11 is also capable of using a frequency band 16 (not illustrated). Here, the frequency bands 15, 16 and 17 correspond to the frequency bands belonging to unlicensed bands.

In FIG. 1, the access point 11 is configured to use three frequency bands: the unlicensed band frequency band 15, the frequency band 16, and the frequency band 17. The access point 11 may be configured to communicate with the terminal device 1 and other devices such as a personal computer by using only a single frequency band, or may be configured to perform communication by using selectively or all of two or four or more frequency bands.

The access point may be configured to communicate with a plurality of devices by using some of available unlicensed bands respectively, and for example, in FIG. 1, the access point 11 may be configured to communicate with the terminal device 1 by using the frequency band 15 and the frequency band 17, and to communicate with, for example, a personal computer, by using the frequency band 16. Further, the terminal device 1 is capable of directly performing wireless communication with the personal computer or a printer having a wireless interface, by using the frequency band 15, according to the specification of 802.11n. Further, the terminal device 1 may directly communicate with other devices, for example, a personal computer or a printer, by using unlicensed frequency bands, for example, the frequency bands 15, 16, and 17, without passing through the access point 11.

FIG. 2 is a block diagram illustrating a configuration of the base station apparatus 3. In FIG. 2, typical circuit parts which are necessary for explanation of communication with the base station apparatus 3, or circuit parts which are directly related to the present invention and are necessary for explanation of the present invention are extracted. Incidentally, since the base station apparatus 3 performs communication with the terminal device 1 according to LTE-A, respective circuit units in FIG. 2 are circuit units which are for communication according to LTE-A. Since the access point 11 also uses the communication scheme of the LTE-A, and has the same circuit units as in FIG. 2, a description of the configuration of the access point 11 is omitted. However, the access point 11 may substitute or add other circuit units to perform communication of LTE-A. For example, a power supply circuit, a power supply switch, an operation unit, a display unit, a pilot lamp, and the like, which do not directly affect the present invention, are omitted.

Although a single circuit unit is described for each circuit, but it may be configured such that a plurality of circuit units are used in combination with each other. For example, it may be configured to use a plurality of antennas, and only one antenna is illustrated in FIG. 2 in order to simplify the explanation.

As illustrated, the base station apparatus 3 is configured to include a higher layer processing circuit unit 301, a control circuit unit 303, a reception circuit unit 305, a transmission circuit unit 307, and a transmit/receive antenna 309. Further, the higher layer processing circuit unit 301 is configured to include a radio resource control circuit unit 3011. Further, the reception circuit unit 305 is configured to include a decoding circuit unit 3051, demodulation circuit unit 3053, a demultiplexing circuit unit 3055, and a wireless reception circuit unit 3057. Further, the transmission circuit unit 307 is configured to include a coding circuit unit 3071, a modulation circuit unit 3073, a multiplexing circuit unit 3075, and a wireless transmission circuit unit 3077.

The higher layer processing circuit unit 301 performs processing for a Medium Access Control (MAC) layer, a Packet Data Convergence Protocol (PDCP) layer, a Radio Link Control (RLC) layer, and a Radio Resource Control (RRC) layer. Further, the higher layer processing circuit unit 301 generates information in order to control the reception circuit unit 305 and the transmission circuit unit 307, and outputs the generated information to the control circuit unit 303. The radio resource control circuit unit 3011 provided in the higher layer processing circuit unit 301 generates downlink data (a transport block), RRC signals, and MAC CE to be disposed in the Physical Downlink Control Channel (PDSCH) of downlink, or obtains them from a higher node, for example, a Radio Network Controller (RNC, unillustrated), and outputs them to the transmission circuit unit 307. Further, the radio resource control circuit unit 3011 performs management of various types of setting information of the terminal device 1. For example, the radio resource control circuit unit 3011 performs management of an identifier (RNTI), such as allocation of Cell-specific Radio Network Temporary Identifier (C-RNTI) to the terminal device 1.

The radio resource control circuit unit 3011 performs management of the cell, which is set to the terminal device 1. The radio resource control circuit unit 3011 controls the transmission circuit unit 307 through the control circuit unit 303 so as to set the DLCC and the ULCC (or the DLCC only) to be used in communication, for each terminal device 1, and notify of control information necessary for this setting (hereinafter, control information) by using the RRC signal, and outputs the control information to the transmission circuit unit 307.

The radio resource control circuit unit 3011 performs management of cells (the DLCC and the ULCC, or the DLCC only) which are set for use in communication with the terminal device 1, and cells (the ULCC and the DLCC, or the DLCC only) which are set for use in communication. Further, the radio resource control circuit unit 3011 is able to control the resources of a component carrier on a cell basis, or a DLCC or ULCC basis. The control can be notified to the terminal device 1, for example, by using RRC signaling.

The radio resource control circuit unit 3011 allocates a part of the frequency band as a communication resource to the terminal device 1, and communicates with the terminal device 1 by using the allocated communication resource. The base station notifies the terminal device 1 of the allocated communication resource by using the DLCC. In this embodiment, the communication resource is roughly classified into two types. A first type is a case of using a frequency band of a licensed band, and a second type is a case of using an unlicensed band. In particular, the communication resources allocated from the part of the licensed band is referred to as a first communication resource, and the communication resources allocated from some or all of the unlicensed bands is referred to as a second communication resource. In other words, the radio resource control circuit unit 3011 performs control so as to allocate some licensed bands as the first communication resource and some unlicensed bands as the second communication resource to the terminal device 1 so as to be used for communication with the terminal device 1. Here, the base station apparatus 3 is able to communicate with the terminal device 1, by using one or both of the first communication resource and the second communication resource as the communication resource.

Further, as described above, the radio resource control management unit 3011 is able to perform control of setting the cell so as to be used in communication or setting so as not to be used in communication. In these controls, it is possible to set the cell (at least one or both of the DLCC and the ULCC) to a use state or non-use state, as the control of the cell.

Here, the use state is a state where it is possible to secure or allocate a part of the frequency band to be used as a communication resource by scheduling, and execute communication with the terminal device 1, and a state that can be used in communication with the terminal device 1. The use state is referred to as an activate state or an activated state, and setting to an activated state is referred to as activating.

On the other hand, the non-use state is a state where it is not possible to secure or allocate a part of the cell or a part of the frequency band as a communication resource by scheduling and a state that cannot be used in communication with the terminal device 1. The non-use state is referred to as a deactivate state or a deactivated state, and setting to a deactivated state is referred to as deactivating.

Thus, the activated state may be referred to as a deactivate-able state, and the deactivated state may be referred to as an activate-able state.

Alternatively, the non-use state may be a released state that is not used as a cell. Hereinafter, if there is no particular mention, it is assumed that using the frequency band of the unlicensed band as the cell of the unlicensed band or an available state means an activated state, and starting the use means activating.

Conversely, if there is no particular mention, it is assumed that not-using the frequency band of the unlicensed band as the cell of the unlicensed band, a deactivated state in which the use is stopped, or stopping the use means deactivating.

In other words, if the cell is activated and scheduled, the cell goes to a state of being available in communication. If the cell is deactivated, the cell cannot be scheduled if it is not activated, and goes to a state that cannot be used. Alternatively, if the deactivated cell is activated, it goes to a use state where scheduling is available and is in a state that can be used in communication with the terminal device 1.

The radio resource control circuit unit 3011 controls the transmission circuit unit 307 through the control circuit unit 303 so as to set DLCC in which control information about cells used in communication is disposed in the terminal device 1, and notify the terminal device 1 of control information about the setting in the RRC signal. The radio resource control circuit unit 3011 controls the transmission circuit unit 307 through the control circuit unit 303 so as to notify the terminal device 1 of control information through the PDCCH or the MAC CE.

The control circuit unit 303 generates a control signal for controlling the reception circuit unit 305 and the transmission circuit unit 307, based on the control information from the higher layer processing circuit unit 301. The control circuit unit 303 outputs the generated control signal to the reception circuit unit 305 and the transmission circuit unit 307 so as to control the reception circuit unit 305 and the transmission circuit unit 307.

The reception circuit unit 305 separates, demodulates, and decodes the received signal which is received from the terminal device 1 through the transmit/receive antenna 309, in response to the input from the control circuit unit 303, and outputs the decoded information to the higher layer processing circuit unit 301. The wireless reception circuit unit 3057 converts (down coverts) the uplink signal which is received through the transmit/receive antenna 309 into a baseband signal through quadrature demodulation, removes unnecessary frequency components, controls the amplification level so as to maintain the signal level properly, performs quadrature demodulation based on the in-phase and quadrature components of the received signal, and converts the quadrature-demodulated analog signal into a digital signal. The wireless reception circuit unit 3057 removes the portion corresponding to the Guard Interval (GI) from the converted digital signal. The wireless reception circuit unit 3057 extracts a signal in the frequency domain by performing the Fast Fourier Transform (FFT) on the signal obtained by removing the guard interval, and outputs the extracted signal to the demultiplexing circuit unit 3055.

The demultiplexing circuit unit 3055 separates signals input from the wireless reception circuit unit 3057 into signals such as a Physical Uplink Control Channel (PUCCH), a Physical Uplink Shared Channel (PUSCH), and an uplink reference signal. The separation is performed, based on radio resource allocation information which is included in the uplink grant, or which is the uplink grant. The uplink grant is that the base station apparatus 3 previously determined in the radio resource control circuit unit 3011 and of which each terminal device 1 is notified. In addition, the demultiplexing circuit unit 3055 compensates for the channel of the PUCCH and the PUSCH, from the estimated value of the channel input from a channel measurement circuit unit (not illustrated). Further, the demultiplexing circuit unit 3055 outputs the separated uplink reference signal to the channel measurement circuit unit (not illustrated).

The demodulation circuit unit 3053 acquires the modulation symbols by performing Inverse Discrete Fourier Transform (IDFT) on the PUSCH, and performs demodulation of the received signal on each modulation symbol of the PUCCH and PUSCH, using a modulation scheme which has been predetermined such as Binary Phase Shift Keying (BPSK), QPSK, 16QAM, 64QAM, or 256QAM or which the own apparatus has previously notified each terminal device 1 through the uplink grant.

The decoding circuit unit 3051 decodes the coded bits of the demodulated PUCCH and PUSCH, with a coding rate which is predetermined or that the base station apparatus previously notifies the terminal device 1 by the uplink grant of a predetermined encoding method, and outputs the decoded uplink data and the uplink control information to the higher layer processing circuit unit 301.

The transmission circuit unit 307 generates a downlink reference signal, in response to the input from the control circuit unit 303, encodes and modulates various types of control information input from the higher layer processing circuit unit 301, for example, downlink control information, downlink data, and control information, multiplexes Physical HARQ Indicator Channel (PHICH), PDCCH, PDSCH, and a downlink reference signal, and outputs the multiplexed signals to the terminal device 1 through the transmit/receive antenna 309.

The coding circuit unit 3071 encodes the control information input from the higher layer processing circuit unit 301, and downlink data, by using a predetermined encoding scheme such as block coding, convolutional coding, and turbo coding, or an encoding scheme which is determined by the radio resource control circuit unit 3011.

The modulation circuit unit 3073 modulates the coded bits input from the coding circuit unit 3071, by using a predetermined modulation scheme such as BPSK, QPSK, 16QAM, 64QAM, and 256QAM, or a modulation scheme which is determined by the radio resource control circuit unit 3011.

The multiplexing circuit unit 3075 multiplexes each modulated channel and the generated downlink reference signal.

The wireless transmission unit 3077 generates an OFDM symbol by performing Inverse Fast Fourier Transform (IFFT) on the multiplexed modulation symbol or the like, generates a baseband digital signal by adding the Cyclic Prefix (CP) to the generated OFDM symbol, converts the baseband digital signal into an analog signal, removes unnecessary frequency components by a low-pass filter, performs up-conversion to a carrier frequency, amplifies the power, and outputs and transmits it to the transmit/receive antenna 309.

Further, each circuit unit described above may be configured only with a circuit which is set to realize the above-mentioned respective functions and respective functions to be described later with a dedicated circuit, as a circuit device such as an Application Specific Integrated Circuit (ASIC), may be configured with both the dedicated circuit unit and software such that some circuits are configured with general-purpose processing circuits, some processes or functions which are executed by each circuit unit are implemented with software by using the general-purpose circuits, or may be configured to be implemented with software by using only the general-purpose processing circuits, without using the dedicated circuit units. In particular, in a case of using the general-purpose processing circuits, respective dedicated general-purpose circuit units may be disposed in the circuit units, but the respective processes may be implemented by providing a single general-purpose processing unit that implements all processes, or a plurality of general-purpose processing units which respectively implement some processes.

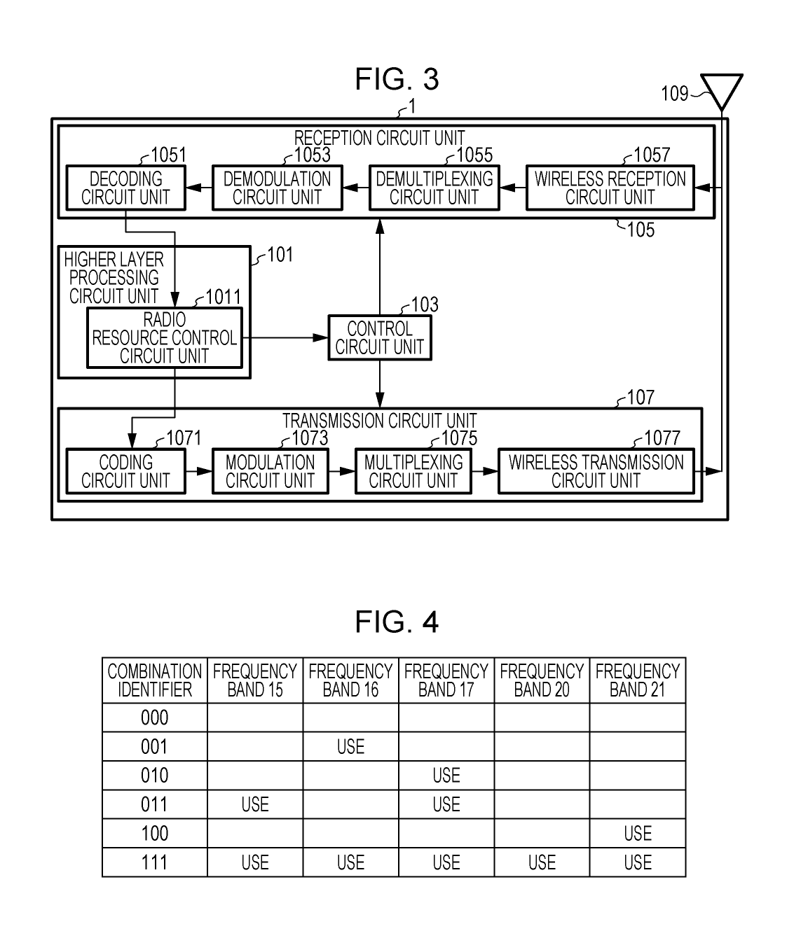

FIG. 3 is a schematic block diagram illustrating the configuration of the terminal device 1 of the present invention. In FIG. 3, representative circuit parts necessary for the communication with the base station apparatus 3, or circuit parts which are directly related to the present invention and necessary for the explanation of the present invention are only extracted. Circuit parts which do not directly affect the present invention, for example, a power supply circuit, a power switch, an operation unit, a display unit, a pilot lamp or the like are omitted.

Further, each circuit unit is illustrated as a single circuit unit, but may be configured with a plurality of circuit units in conjunction with each other. For example, a configuration is possible in which a plurality of antennas are used, and FIG. 3 illustrates only one for simplicity of explanation.

As illustrated, the terminal device 1 is configured to include a higher layer processing circuit unit 101, a control circuit unit 103, a reception circuit unit 105, a transmission circuit unit 107, and a transmit/receive antenna 109. Further, the higher layer processing circuit unit 101 is configured to include a radio resource control circuit unit 1011. The reception circuit unit 105 is configured to include a decoding circuit unit 1051, a demodulation circuit unit 1053, a demultiplexing circuit unit 1055, and a wireless reception circuit unit 1057. The transmission circuit unit 107 is configured to include a coding circuit unit 1071, a modulation circuit unit 1073, a multiplexing circuit unit 1075, and a wireless transmission circuit unit 1077.

The higher layer processing circuit unit 101 outputs the uplink data, the RRC signal, and the MAC CE, which are generated by the user's operation or the like, to the transmission circuit unit 107. Further, the higher layer processing circuit unit 101 performs processing for a Medium Access Control (MAC) layer, a Packet Data Convergence Protocol (PDCP) layer, a Radio Link Control (RLC) layer, and a Radio Resource Control (RRC) layer. Further, the higher layer processing circuit unit 101 generates information for controlling the reception circuit unit 105 and the transmission circuit unit 107, based on the downlink control information or the like which is received in the PDCCH, and outputs the generated information to the control circuit unit 103. The radio resource control circuit unit 1011 provided in the higher layer processing circuit unit 101 manages various types of setting information of the terminal device. For example, the radio resource control circuit unit 1011 manages an identifier such as C-RNTI. Further, the radio resource control circuit unit 1011 generates information disposed in each uplink channel, and outputs the generated information to the transmission circuit unit 107.

The radio resource control circuit unit 1011 manages the cell according to the notification using the RRC signal that is notified from the base station apparatus 3. Further, the radio resource control circuit unit 1011 can also control component carriers in a cell unit or in a DLCC or ULCC unit. Here, the management of a cell is performed as described above, and includes controls of a use state or a non-use state, more specifically, activating or deactivating, or connection establishment or release, on a cell basis, or a ULCC or DLCC basis.

The control circuit unit 103 generates a control signal for controlling the reception circuit unit 105 and the transmission circuit unit 107, based on information from the higher layer processing circuit unit 101. The control circuit unit 103 outputs the generated control signal to the reception circuit unit 105 and the transmission circuit unit 107 so as to control the reception circuit unit 105 and the transmission circuit unit 107. The reception circuit unit 105 separates, demodulates, and decodes the received signal received from the base station apparatus 3 through the transmit/receive antenna 109 in response to the control signal input from the control circuit unit 103, and outputs the decoded information to the higher layer processing circuit unit 101.

The wireless reception circuit unit 1057 converts (down coverts) the downlink signal which is received through the transmit/receive antenna 109 into a baseband frequency, removes unnecessary frequency components, controls the amplification level so as to maintain the signal level properly, performs quadrature demodulation based on the in-phase and quadrature components of the received signal, and converts the quadrature-demodulated analog signal into a digital signal. The wireless reception circuit unit 1057 removes the portion corresponding to the Guard Interval (GI) from the converted digital signal, and extracts a signal in the frequency domain by performing the Fast Fourier Transform (FFT) on the signal obtained by removing the guard interval.

The demodulation circuit unit 1053 performs demodulation of a Binary Phase Shift Keying (BPSK) modulation scheme on PHICH, and outputs the demodulated signal to the decoding circuit unit 1051. The decoding circuit unit 1051 decodes PHICH addressed to the terminal device, and outputs the decoded HARQ indicator to the higher layer processing circuit unit 101. The demodulation circuit unit 1053 performs demodulation of a QPSK modulation scheme on PDCCH, and outputs the demodulated signal to the decoding circuit unit 1051. The decoding circuit unit 1051 attempts blind decoding of PDCCH, and if blind decoding is successful, it outputs the decoded downlink control information and the RNTI that is included in the downlink control information to the higher layer processing circuit unit 101.

The demodulation circuit unit 1053 performs demodulation of a modulation scheme which is notified in the downlink resource allocation (Resource assignment, scheduling information) such as Quadrature Phase Shift Keying (QPSK), 16 Quadrature Amplitude Modulation (QAM), 64QAM, and 256QAM on PDSCH, and outputs the demodulated signal to the decoding circuit unit 1051. The decoding circuit unit 1051 performs decoding based on the information about the coding rate which is notified in the downlink control information, and outputs the decoded downlink data (transport block) to the higher layer processing circuit unit 101.

The transmission circuit unit 107 generates a uplink reference signal according to the control signal input from the control circuit unit 103, encodes and modulates the uplink data (transport block) input from the higher layer processing circuit unit 101, multiplexes PUCCH, PUSCH, and the generated uplink reference signal, and outputs the multiplexed signals to the base station apparatus 3 through the transmit/receive antenna 109. The coding circuit unit 1071 performs encoding such as convolutional coding and block coding on the uplink control information input from the higher layer processing circuit unit 101, and performs turbo coding on the uplink data based on information about the coding rate which is notified in the uplink grant. The modulation circuit unit 1073 modulates the coded bits input from the coding circuit unit 1071, in a modulation scheme which is notified through the downlink control information, such as BPSK, QPSK, 16QAM, and 64QAM, or in a modulation scheme which is predetermined for each channel.

The wireless transmission circuit unit 1077 performs Inverse Fast Fourier Transform (IFFT) on the multiplexed signal, performs modulation of a SC-FDMA scheme, and adds a CP to the SC-FDMA modulated SC-FDMA symbols so as to generate a digital baseband signal, converts the baseband digital signal into an analog signal, converts it into a high frequency signal (up converts) and, removes unnecessary frequency components, amplifies the power, and outputs and transmits it to the transmit/receive antenna 109.

Further, each circuit unit described above may be configured only with a circuit which is set to realize the above-mentioned respective functions and respective functions to be described later with a dedicated circuit, as a circuit device such as an Application Specific Integrated Circuit (ASIC), may be configured with both the dedicated circuit unit and software such that some circuits are configured with general-purpose processing circuits, some processes or functions which are executed by each circuit unit are implemented with software by using the general-purpose circuits, or may be configured to be implemented with software by using only the general-purpose processing circuits, without using the dedicated circuit units. In particular, in a case of using the general-purpose processing circuits, respective dedicated general-purpose circuit units may be disposed in the circuit units, but the respective processes may be implemented by providing a single general-purpose processing unit that implements all processes, or a plurality of general-purpose processing units which respectively implement some processes.

Next, a setting method and a use method of unlicensed bands in the present embodiment will be described. In use of the unlicensed bands, the base station apparatus 3 notifies the terminal device 1 of necessary control information. The control information can include one or both of licensed band control information which is first control information including control information (or control information necessary for the frequency band of the licensed band) about the cell 5 or the cell 7 which is the licensed band, or cells using other licensed bands (hereinafter, the cell of the licensed band), and unlicensed band control information which is second control information including control information (or control information necessary for the frequency band of the unlicensed band) about cells using unlicensed bands (hereinafter, the cells of the unlicensed bands).

Further, the unlicensed band control information may be notified as the control information with the licensed band control information from the base station apparatus 3 to the terminal device 1, or may be notified by using the control information without the licensed band control information to the terminal device 1. In other words, the control information which is notified to the terminal device 1 from the base station apparatus 3 may include one of or both the licensed band control information and the unlicensed band control information.

Next, a description will be given on the control in the case where the unlicensed band is started to be used in the communication between the base station apparatus 3 and the terminal device 1. With respect to the unlicensed band, similar to the licensed band, the base station apparatus 3 controls and manages the frequency band of the unlicensed band, by regarding a single cell which is configured with the frequency band of the unlicensed band as a single unit (cell). Hereinafter, the cell is referred to as a cell of the unlicensed band. Especially, when the terminal device 1 communicates with the base station apparatus 3 by applying the same communication scheme as in the cell of the licensed band, to the cell of the unlicensed band, the frequency band constituting the cell of the unlicensed band is referred to as the frequency band as the cell of the unlicensed band, or simply referred to as the cell of the unlicensed band. The frequency band constituting the cell of the unlicensed band may also referred to as the frequency band which is used as the cell of the unlicensed band, or the frequency band as the cell of the unlicensed band. Hereinafter, these may also be referred to as “using the frequency band as a cell of the unlicensed band.”

In the communication between the base station apparatus 3 and the terminal device 1, for example, in case where the frequency bands 15 and 17 are started to be used as a cell between the terminal device 1 and the base station apparatus 3, the unlicensed band control information is used. In other words, when starting to use the unlicensed band in the communication with the terminal device 1, the base station apparatus 3 notifies the terminal device 1 of the unlicensed band control information. More specifically, the unlicensed band control information is generated by the radio resource control circuit unit 3011 by being included in the control information, and is notified to the terminal device 1 by the transmission circuit unit 307.

The radio resource control circuit 3011 of the base station apparatus 3 determines to start the use of the cell of the unlicensed band, and selects the frequency band 17 as the cell of the unlicensed band. Here, the start of using indicates activating the frequency band of the unlicensed band as the cell of the unlicensed band to be described later. The base station apparatus 3 informs the terminal device 1 of a new start of using the frequency band 17. Specifically, information indicating the frequency band 17 is generated as the unlicensed band control information, and is notified to the terminal device 1. As the unlicensed band control information in this case, the terminal device 1 is notified of control information including information indicating the cell of the unlicensed band to be used (can be referred to as information for identifying the cell of the unlicensed band or information indicating the frequency band that cannot be exclusively used). Since the frequency band 17 is started to be used as the cell of the unlicensed band, here, information indicating the cell of the unlicensed band includes information for identifying the frequency band 17. The information for identifying the frequency band 17 may be, for example, information about the frequency of the frequency band 17.

Examples of the information about the frequency may be information on the frequency band. Examples of the information on the frequency band may be represented as information indicating a frequency. As the information indicating the frequency, the center frequency or the bandwidth may be used, or the upper and lower limits of a frequency band may be used. Alternatively, in a case where the center frequency and the frequency bandwidth are uniquely determined, only the center frequency may be used, and if the frequency band can be specified, hereinafter, it is simply described as a frequency, without being particularly limited. Further, when a plurality of frequency bands are combined and used, one or both of a plurality of indexes and frequencies may be notified.

If identifiers or indexes are prepared in advance, the frequencies may be substituted or used in combination with each other. In other words, information about the frequency may be any information that can specify directly or indirectly the frequency information, and can be rephrased as information indicating the frequency information or frequency information. In a case where, for example, a 2.4 GHz band, a 5.2 GHz band, and a 5.5 GHz band are used as frequencies, and an index 1, an index 2, and an index 3 are respectively prepared for the 2.4 GHz band, the 5.2 GHz band, and the 5.5 GHz band, the base station apparatus 3 may be configured to notify the terminal device 1 of any one of the indexes 1 to 3.

The correspondence between the identifier and the index may not be determined in advance, and a frequency may be specified based on the identifier and the index. For example, the frequency 2.4 GHz band, the frequency 5.2 GHz band, and the 5.5 GHz band may respectively be specified by the index 24, the index 52, and the index 55. In this manner, it can be configured such that the frequency information is specified based on the indexes and particular conversion expressions or relationships which are defined in advance. In this case, for example, it is possible to use an RRC connection Reconfiguration message (see TS36.331 v10.3.0) which is an existing message in the LTE-A. In this message, in a case where a new cell is added to the cell, the base station apparatus 3 can instruct the terminal device 1 to add a cell by using the cell number and the frequency information.

Here, it is possible to give an instruction to use or not to use all of the frequency bands that can be used as the cells of the unlicensed bands. In a case of using all of the frequency bands that can be used as the cells of the unlicensed band, the frequency information or simply the frequency of all of the frequency bands that can be used as the cells of the unlicensed band may be notified. Conversely, in a case of not using all of the frequency bands that can be used as the cells of the unlicensed band, the frequency information or simply the frequency of all of the frequency bands that can be used as the cells of the unlicensed band may not be notified.

Incidentally, it is possible to define respective channels which are formed by subdividing a single frequency band, as frequency bands. For example, the frequency band of the 2.4 GHz band is divided into, for example, n frequency bands, and individual identifiers or individual frequency information may be used for the divided frequency bands. They may be determined according to the specification (for example, 802.11n) applied to the communication with other devices using the unlicensed band.

A method of designating frequency bands using respective cells, in other words, the cells of the unlicensed band, as the unlicensed band control information will be described using FIG. 4. In FIG. 4, the frequency bands 15, 16, 17, 20, and 21 are indicated as available unlicensed bands. In the present embodiment, the frequency bands that the terminal device 1 can use are frequency bands 15, 16, and 17, and the terminal device 1 does not use the frequency bands 20 and 21. However, another terminal device 1A (not illustrated) can use only the frequency bands 20 and 21, rather than the frequency bands 15, 16, and 17, a terminal device 1B (not illustrated) can use not only the frequency bands 15, 16, and 17, but also the frequency bands 20 and 21, a terminal device 1C (not illustrated) may be configured to use only the frequency bands 17 and 21, and there may be terminal devices of a simple configuration which cannot use the unlicensed band.

However, terminal devices which cannot use the unlicensed band and the base station apparatus 3 may communicate by using only the licensed band, and the description is omitted in this specification. Since the frequency band of the unlicensed band that can be used with the terminal device depends on the configuration, such as which frequency band the terminal device supports, it is not particularly limited in the present invention.

In FIG. 4, combinations of “use” and “non-use” of the unlicensed band for these frequency bands are made, and identifiers (hereinafter, referred to as combination identifiers) are assigned to respective combinations. The relationship between the combination and the combination identifier may be determined in advance, and may be common in the base station apparatus 3 and the terminal device 1. For example, the combination identifier 010 indicates that only the frequency band 17 is used as the cell of the unlicensed band. When changing the cell of the unlicensed band to be used, for example, when changing the cell from the frequency band 17 to the frequency band 16, it is possible to change the frequency bands to be used as the cells of the unlicensed bands from the frequency band 17 to the frequency band 16, by sending the combination identifier 001 to the terminal device 1. It is possible to give an instruction to change the frequency band to “use” or “non-use” as the cell of the unlicensed band, add the frequency band to be used, remove the frequency band which is in use (or excludes, that is, not to use), and stop the use of the unlicensed band as the cell, by sending the combination identifier in this manner. Here, the combination may be a combination relating to at least two or more frequency bands which are in use as the cells of the unlicensed bands, but the combination may be used as an identifier indicating the frequency band to be used as a cell of a single unlicensed band such as 001 and 010 in FIG. 4. The combination identifier can also be expressed as information indicating the frequency band to be used as the cell of the unlicensed band to be used, which indicates the frequency band to be used as the cell of the unlicensed band. Combinations for the frequency bands 20 and 21 are defined in FIG. 4, but are combinations used for the terminal device which supports the frequency bands 20 and 21. Alternatively, the combinations are used even in the case where the terminal device 1 moves to the communication environment in which the frequency bands 20 and 21 which are unlicensed bands are used, but as described above, since the terminal device 1 is a device which is not capable of using the frequency bands 20 and 21, the setting for the frequency bands 20 and 21 may be ignored.

In addition, it is not necessary to set the combination identifiers for all the combinations which are used or are not used (referred to as non-use) for the frequency bands. For example, in FIG. 4, combinations for the presence or absence of the use for five frequency bands are prepared, and instead of allocating identifiers to the combinations, identifiers are allocated only to the combinations which are considered to be required. This enables a reduction in the number of bits of the combination identifier.

For example, the use combinations of the five frequency bands are defined in FIG. 4, and five bits are required in order to represent all the combinations, but the combination identifier is suppressed to 3 bits in FIG. 4. It is possible to represent eight types of combinations because the bits used in FIG. 4 are three bits, but it is not necessary to assign combinations of frequency bands to be used for all that can be represented by combination identifiers.

Only six identifiers are depicted in FIG. 4, and specifically, 101 and 110 are not present. This does not indicate that there is a reason that 101 and 110 are not available, and for example, 101 and 110 are secured (reserved) for the case where a separate frequency band 22 or the like other than the frequency bands 15 to 21 is changed to be used as the cells of the unlicensed band. Alternatively, if the frequency bands, which can be used as the existing unlicensed band, are intended to be used differently, 101 and 110 can be used.

For example, although the frequency band 20 is not used alone in FIG. 4, in a case where the frequency band 20 is needed to be used alone as the cells of the unlicensed band, the base station apparatus 3 assignes and uses an identifier that is not currently in use, for example, a combination identifier 101 to the terminal device 1 for the use of the frequency band 20 alone, and the base station apparatus 3 may instruct the terminal device 1 to use the frequency band 20 alone. Alternatively, in a case of using the frequency bands 15 and 16 which is a combination of frequency bands that are not present in FIG. 4, the base station apparatus 3 may instruct the terminal device 1 to use the frequency bands 15 and 16, by using an identifier that is not currently in use, for example, a combination identifier 110.

It is possible to control the use of the unlicensed band as follows by using the configuration illustrated in FIG. 4. Since the unlicensed band is a band which cannot be exclusively used as described above, it is can be fount that it is not desirable that the base station apparatus 3 and the terminal device 1 exclusively use the unlicensed band over a long period of time.

In a case where terminal device 1 and the base station apparatus 3 handle temporarily very large amount of user data, the base station apparatus 3 notifies the terminal device 1 of for example, the combination identifier 011, and uses the frequency bands 15 and 17 as the cells of the unlicensed band. At a time when the communication of very large amount of data is completed, the base station apparatus 3 notifies the terminal device 1 of 010 as the combination identifier, only the frequency band 17 is used as the cells of the unlicensed band, and the frequency band 15 is released and returned to a state that can be used not only by the terminal device 1 but also by other devices.

Conversely, for example, when only the frequency band 17 is used at present, if communication of large amount of data is temporarily needed, it may be configured that the base station apparatus 3 notifies the terminal device 1 of 011 as the combination identifier, and the frequency bands 15 and 17 are used in combination with each other as the cells of the unlicensed band in communication between the base station apparatus 3 and the terminal device 1. Of course, as described above, at a time when the communication of very large amount of data is completed, the base station apparatus 3 notifies the terminal device 1 of 010 as the combination identifier, only the frequency band 17 is used as the cells of the unlicensed band, and the frequency band 15 is released and returned to a state that can be used not only by the terminal device 1 but also by other devices. Alternatively, the base station apparatus 3 notifies the terminal device 1 of the combination identifier 001, and may set only the frequency band 16 to be used as the cells of the unlicensed band, or the base station apparatus 3 notifies the terminal device 1 of the combination identifier 000, and may set all of the frequency bands of the unlicensed band to a non-use state as the cells of the unlicensed band. In this sense, 000 can be said as information which does not indicate all frequency bands as the frequency bands which are used as the cells of the unlicensed band, or information which does not indicate all frequency bands as the cells of the unlicensed band.

In the present embodiment, the combination identifier is notified from the base station apparatus 3 to the terminal device 1 as the unlicensed band control information, based on FIG. 4, and in a case where the base station apparatus 3 uses the frequency band 17 as the unlicensed band, 010 is selected as the combination identifier.

In other words, when the base station apparatus 3 starts to use the frequency band 17 as the unlicensed band, in order to notify the terminal device 1 of starting to use the frequency band 17 as the cell of the unlicensed band, the combination identifier 010 is included as the unlicensed band control information in the control information and notified to the terminal.

On the other hand, the terminal receives the control information, and controls the frequency bands to a state of being used as the cells of the unlicensed band (a use state) or a state of not being used (a non-use state), according to the unlicensed band control information included therein. More specifically, in a case where the unlicensed band control information is included in the control information received by the reception circuit unit 105 of the terminal device 1, the radio resource control circuit unit 1011 controls the frequency band so as to be used or not to be used as the cells of the unlicensed band, according to the combination identifier which is the unlicensed band control information.

In the present embodiment, the combination identifier 010 is received as the unlicensed band control information from the base station apparatus 3, and the frequency band 17 is set to be used as the cells of the unlicensed bands according to the identifier.

Further, in a case where the base station apparatus 3 determines to use all the frequency bands that the terminal device 1 can use, as the cells of the unlicensed bands, the base station apparatus 3 notifies of the combination identifier 111 which is the unlicensed band control information as the control information, as information indicating all the frequency bands of the unlicensed bands. The terminal device 1 receives the control information, and controls the frequency bands 15, 16, and 17 so as to be used, which are all frequency bands which can be used as the cells of the unlicensed bands.

Here, a description will be given on the cells of the unlicensed band. As described above, the unlicensed band is a frequency band for which the exclusive use is not permitted in the communication between the base station apparatus 3 and the terminal device 1. Further, the unlicensed band is a frequency band that unspecified number of users can use. Therefore, it is not desirable that the communication between the base station apparatus 3 and the terminal device 1, which is the communication using the unlicensed band, gives influence to the communication by the unspecified number of users.

For example, when the terminal device 1 communicates with the base station apparatus 3 by using the frequency band 15 as the cells of the unlicensed band, or when in particular, the terminal device 1 transmits data to the base station apparatus 3 by using the frequency band 15, in other words, performs uplink communication, it is possible to conceive the case where the CSMA/CA communication using the frequency band 15 is performed in the vicinity of the terminal device 1.

In particular, in a case where the base station apparatus 3 is a base station of a macro cell, there is a possibility that the transmit power from the terminal device 1 to the base station apparatus 3 is much greater than the power used in the CSMA/CA communication, and there is a possibility that affects the CSMA/CA communication. For example, it may provide the deterioration in the communication quality such as causing interference in the CSMA/CA communication.

Interference to other devices due to the transmission of the terminal device 1 may occur by uplink communication using the cells of the unlicensed bands, in other words, the communication using ULCC. Thus, it is possible to use DLCC and ULCC as the cells of the unlicensed bands, but cells may deliberately be configured only with DLCC sometimes. Alternatively, when using a plurality of frequency bands as the cells of the unlicensed bands, instead of using ULCC and DLCC for all frequency bands, it can be configured to use only DLCC without using ULCC in the cells of at least one unlicensed band or the cells in all unlicensed bands.

For example, in a case where the base station apparatus 3 which performs communication is a base station of a macro cell, the cells of the unlicensed bands may be constituted only by DLCC without including ULCCs. In a case where the base station apparatus 3 is a home base station or a base station of a small cell, the cells of all unlicensed bands may be configured with DLCC and ULCC, and some may be configured with DLCC and ULCC, and the rest may be configured with only DLCC.

For example, in a case of using the combination identifiers of FIG. 4, if the base station apparatus 3 which performs communication is a base station of a macro cell, without being explicitly instructed, the cell of the unlicensed band is DLCC, and the base station apparatus 3 uses DLCC of each frequency band (the frequency bands 15, 16, and 17).

The terminal device 1 performs control so as not to use the ULCC, with respect to all respective frequency bands, in other words, in the frequency bands 15, 16, and 17, that is, the terminal device 1 does not perform an uplink process from the base station apparatus 3 in the frequency bands 15, 16, and 17. The frequency bands, in which the terminal device 1 actually performs a reception process, are set according to the combination identifier which is transmitted from the base station apparatus 3 to the terminal device 1. In other words, the terminal device 1 performs the reception of DLCC only in the frequency band indicated by the combination identifier which is transmitted from the base station apparatus 3.

On the other hand, in a case where the base station apparatus 3 is a home base station, without explicit instructions, the cells of the unlicensed band are DLCC and ULCC, and the base station apparatus 3 uses the DLCC and the ULCC in each frequency band (frequency bands 15, 16, and 17). The terminal device 1 may perform control so as to use the ULCC and the DLCC in the frequency bands indicated by the combination identifier, with respect to the all respective frequency bands.

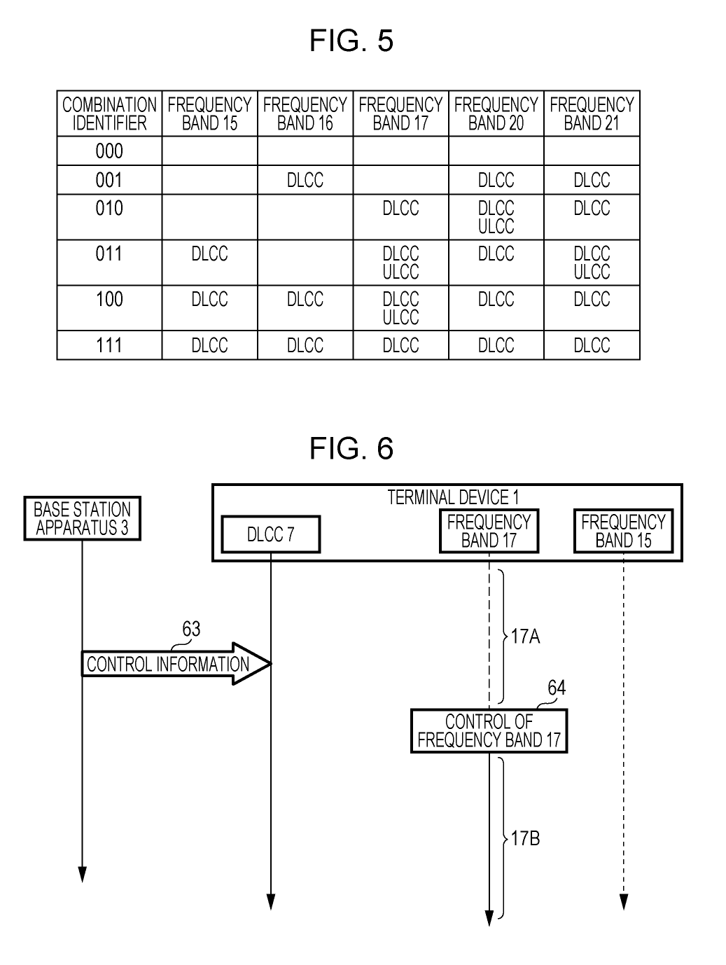

FIG. 5 illustrates another example. Although there are significantly many combinations for the presence or absence of the use of frequency bands and the presence or absence of the use of ULCC and DLCC, similar to the concept in FIG. 4, the combinations are limited to necessary combinations among combinations of the presence or absence of the use of frequency bands and the presence or absence of the use of ULCC and DLCC.

For example, in a case where the terminal device 1 is notified of the combination identifier 010 as the unlicensed band control information, the terminal device 1 performs control so as to use only the frequency band 17 as the cell of the unlicensed band, and to use only DLCC without using the ULCC. Alternatively, in a case where the terminal device 1 is notified of the combination identifier 011 as the unlicensed band control information, the terminal device 1 performs control so as to use the frequency band 17 and the frequency band 15 as the cells of the unlicensed band, and especially, to use only DLCC without using the ULCC in the frequency band 15.

Even in this configuration, for example, even in a case where the combination identifier 011 is notified, for example, if the base station apparatus 3 is a base station of a macro cell, without explicit instruction from the base station apparatus 3, only DLCC may be controlled to a non-use state, without using the ULCC. Further, similar to the case of FIG. 4, the combination identifiers which are not used are simply being secured (reserved).

The combination identifiers are used to designate the frequency bands to be used as the cells of the unlicensed bands in FIG. 4 and FIG. 5. In particular, in a case of using all the frequency bands as the unlicensed bands, 111 is used as the information combination identifier indicating all frequency bands of the unlicensed band. In a case where the frequency bands that can be used as the cells of the unlicensed bands by the terminal device 1 are only three frequency bands 15, 16, and 17, it indicates the use of only three frequency bands which are available.

On the other hand, in a case where the terminal device 1A (not illustrated) is communicating with the base station apparatus 3, and the terminal device 1A can use the frequency bands 20 and 21 as the cells of the unlicensed bands, if the combination identifier 111 is transmitted to the terminal device 1A, the terminal device 1A uses only the frequency bands 20 and 21. In other words, the terminal device uses only the frequency bands that can be controlled by the terminal device itself, among frequency bands which are indicated by the combination identifiers, depending on the capability of the terminal device, and may ignore the instruction from the base station apparatus 3 with respect to the frequency bands that cannot be controlled by itself.

Further, in a case of using all frequency bands of the unlicensed band as the cells of the unlicensed band, the base station apparatus 3 notifies the terminal device 1 of information indicating the use of all frequency bands (referred to as first use information). It is possible to set or instruct to perform control (first unlicensed band control) such that the terminal device uses all frequency bands as the cells of the unlicensed band, by using the combination identifier as the first use information. In the present embodiment, 111 which is one of the combination identifiers is allocated as the information indicating the use of all frequency bands as the cells of the unlicensed band, but the terminal device may be notified of control of using all frequency bands as the cells of the unlicensed band, by separately preparing and using dedicated information or a dedicated message which is information different from the combination identifier and indicates the use of all frequency bands. In other words, the first use information may be dedicated information or a dedicated message.

Conversely, in a case of setting or instructing the control of all frequency bands to a state of not being used as the cells of the unlicensed band (second unlicensed band control), the base station apparatus 3 notifies the terminal device 1 of information indicating that all frequency bands are not used (referred to as second use information). The combination identifier 000 may be notified as the second use information as in FIG. 4. Alternatively, instead, the terminal device may be notified of controlling all frequency bands to a state of not being used as the cells of the unlicensed band, by separately preparing and using dedicated information or a message indicating that all frequency bands are not used. In other words, the second use information may be dedicated information or a dedicated message. In this sense, the dedicated information or the dedicated message can be said as information which does not indicate all frequency bands as the frequency bands which are used as the cells of the unlicensed band, or information which does not indicate all frequency bands as the cells of the unlicensed band.

The dedicated information has an advantage of capable of indicating the first unlicensed band control or the second unlicensed band control with less information amount than the combination identifier as described below. For example, the number of bits of the combination identifier is three in FIG. 4 and FIG. 5, but it is possible to indicate the first unlicensed band control or the second unlicensed band control with one bit or two bits as described below.

Further, it may be configured to indicate third unlicensed band control which is different from the first unlicensed band control and the second unlicensed band control by a combination of the dedicated information (the dedicated message) and information indicating the frequency bands which are used or are not used as the unlicensed bands, which is represented by the combination identifiers illustrated in FIG. 4 and FIG. 5 (the third unlicensed band control may include a concept in which control about the cells of the unlicensed band is not performed). With the third unlicensed band control, the base station apparatus 3 can give an instruction to the terminal device 1, by not notifying of dedicated information (a dedicated message), or notifying of unlicensed band control information other than dedicated information (a dedicated message) without notifying of the dedicated information (the dedicated message).

For example, the dedicated information (the dedicated bit) formed of at least one bit is notified from the base station apparatus 3 to the terminal device 1. The dedicated information may be transmitted together with the other control information or may be transmitted alone from the base station apparatus 3 to the terminal device 1.

First, a description will be given on a case where the dedicated bit is one bit. When the dedicated bit is 1, all available frequency bands are used as the cells of the all unlicensed bands, in other words, the first unlicensed band control is performed. When the dedicated bit is 0, the use of the cells of the all unlicensed bands which are in use is stopped (control of setting all frequency bands to a non-use state of not being used as the cells of the unlicensed bands), in other words, the second unlicensed band control is performed.

In a case where the dedicated bit is not transmitted, the third unlicensed band control is performed. In other words, as FIG. 4 and FIG. 5, when the combination identifier is separately received as the unlicensed band control information, control related to the cells of the unlicensed band is performed in accordance with the combination identifier. On the other hand, in a case where the unlicensed band control information is not received, the control related to the use start/stop of the unlicensed bands is not performed.

The dedicated bit may be transmitted by being added to other control information, or may be transmitted either alone or by forming a separate message along with information required for the control of the cells of the unlicensed band, from the base station apparatus 3 to the terminal device 1.

The dedicated bit may be two or more bits, without being limited to one bit. In a case of two bits, for example, the following control is possible. When the dedicated bit is 11, the first unlicensed band control is performed.

When the dedicated bit is 00, the second unlicensed band control is performed. In a case where the dedicated bit is not transmitted or the dedicated bit is 01 or 10, the third unlicensed band control is performed. In a case where the dedicated bit is not transmitted, the control related to the use start/stop of the unlicensed bands is not performed. When the dedicated bit is 01, it is indicated that separate unlicensed band control information is to be notified. However, it is assumed that the combination identifier included in the unlicensed band control information in this case is as in FIG. 4. When the dedicated bit is 10, it is indicated that separate unlicensed band control information is to be notified. However, it is assumed that the combination identifier included in the unlicensed band control information in this case is as in FIG. 5. Here, in a case of using FIG. 4, different from FIG. 5, it is assumed that both DLCC and ULCC are used as the cells of the unlicensed band to be used.

Even in a case where the dedicated bit is two or more bits, the dedicated bit may be transmitted by being added to other control information, or may be transmitted either alone or by forming a separate message along with information required for the control of the cells of the unlicensed band, from the base station apparatus 3 to the terminal device 1.

Further, the instruction of the third unlicensed band control is not limited to the use of the combination identifier such as in FIG. 4 and FIG. 5, and it may be configured to use the frequency information described above. For example, in a case where the frequencies of the frequency bands 15 to 17 which are the unlicensed bands in the present embodiment are respectively F15, F16, and F17, if the frequency band 17 is used as the cells of the unlicensed band, information indicating F17 which is frequency number information may be notified by being included in the control information.

In a case of adding the frequency band 15 in a state of using the frequency band 17, the base station apparatus 3 may notify the terminal device 1 of F15 and F17 as the frequency information. Since the terminal device 1 is using the frequency band 17, it is found that the frequency band 15 may be added, and the frequency band 15 is controlled so as to be used as the cells of the unlicensed band. Alternatively, since only F15 is notified as the frequency information of the frequency band to be added, it may be instructed to directly control the frequency band 15 so as to be used as the cells of the unlicensed band.

Conversely, for example, in a case of changing a state of using the frequency bands 15 and 17 to a state where only the frequency band 15 is not used (the frequency band 17 is used subsequently), the base station apparatus 3 may notify the terminal device 1 of F17. In this case, the terminal device 1 recognizes that only the frequency band 17 is used as the cells of the unlicensed band and the frequency band 15 is not used, it controls the frequency band 15 to a state of not being used. Alternatively, it may be instructed to directly control the frequency band 15 to a non-use state of not being used as the cells of the unlicensed band, by notifying F15 as the information on the frequency bands which are not used.

In this manner, the base station apparatus 3 may notify the terminal device 1 only of the frequency bands to be controlled by the terminal device 1, and this enables a reduction in the amount of information to be notified in some cases.

Incidentally, upon instructing the second unlicensed band control, the dedicated information (the dedicated message) is used as described above, but it is possible to instruct the second unlicensed band control by using a mechanism for instructing the third unlicensed band control. Specifically, the base station apparatus 3 instructs the terminal device 1 to perform the second unlicensed band control (or the first unlicensed band control), by notifying the combination identifier 000 (or 111) in FIG. 4 or FIG. 5, without transmitting the dedicated information (the dedicated message).

Alternatively, it may be instructed to directly control the frequency bands 15, 16, and 17 so as not to be used as the cells of the unlicensed bands, by notifying the frequency information of all available frequency bands, F15, F16, and F17 in the case of the present embodiment as the information of the frequency bands which are not used, without transmitting the dedicated information (the dedicated message). In the above, F15, F16, and F17 are used as the information indicating frequency as described above, but the information may be information indicating specific frequency, or information such as an index indicating a frequency, as described above. Further, if the indexes of the frequency bands are known, instead of the information indicating the frequency, the index of the frequency band may be notified together with the frequency information.

### Second Embodiment

In the first embodiment, a description has been given on the setting method and the use method of the cells of the unlicensed band. For example, a description has been given on the use of the control information and the unlicensed band control information, but in the present embodiment, a method of notifying the terminal of the control information and the unlicensed band control information will be described specifically.

The control information is generated by the radio resource control circuit unit 3011 of the base station apparatus 3 as described above, and is notified by the transmission circuit unit 307 to the terminal device 1 through the transmit/receive antenna 309. The control information may be notified by using the cell 7 which is the primary cell, or may be notified by using the cell 5 which is the secondary cell. In particular, in a case where no frequency band is set as the cell of the unlicensed band and only the licensed band is used as the cells 5 and 7, the control information is transmitted by using the cell 5 or the cell 7.

Incidentally, in a case where the cell of the unlicensed band is already used, the notification of the control information is sent to the terminal by using the cell of the unlicensed band. Conversely, even in a case where the cell of the unlicensed band is used, the cell of the unlicensed band is not used for the notification of the control information, and the notification of the control information may be sent to the terminal device 1 only by using the cell of the licensed band. Here, as a method of notifying the terminal device 1 of the control information applied to the cell of the unlicensed band, that is, unlicensed band control information, it is possible to use selectively or both a first notification method performed by using the cell of the licensed band, and a second notification method performed by using the cell of the existing unlicensed band, or it is possible to use only the first notification method. On the other hand, in a case where the cell of the unlicensed band is already used, it may be configured such that notification is sent only by using the second notification method.

When receiving the control information including the unlicensed band control information, in a case where the base station apparatus 3 uses the first notification method, the terminal device 1 executes a first acquisition method of acquiring the control information including the unlicensed band control information only from the licensed band; and in a case where the base station apparatus 3 uses the second notification method, the terminal device 1 executes a second acquisition method of acquiring the control information from the unlicensed band. In a case where the base station apparatus 3 uses both the first notification method and the second notification method, the terminal device 1 uses both the first acquisition method and the second acquisition method. In a case where the base station apparatus 3 uses only the first notification method, the terminal device may execute only the first acquisition method.

The present embodiment is illustrated in FIG. 6. The downward direction in FIG. 6 is a direction representing an elapsed time. The base station apparatus 3 notifies the terminal device 1 of the control information by using DLCC 7 (corresponding to an arrow 63 in FIG. 6). In the present embodiment, only the frequency band 17 is used as the cell of the unlicensed band. Therefore, the control information includes a combination identifier 010 as unlicensed control information. If the terminal device 1 (the reception circuit unit 105) receives the control information, the radio resource control circuit unit 1011 controls the frequency band 17 so as to be used as the cell of the unlicensed band in accordance with the control information (64 in FIG. 6).

The frequency band 17 is not used as the cell of the unlicensed band before this control (17A in FIG. 6), but the frequency band 17 is used as the unlicensed band with this control. This corresponds to 17B in FIG. 6. In FIG. 6, in a state where the frequency band 17 which can be used as the cell of the unlicensed band is not used as the cell of the unlicensed band, the control information of the unlicensed band (the combination identifier 010) is acquired, and the frequency band 17 is started to be used (activated) as the cell of the unlicensed band. The control information may be an instruction to activate the frequency band 17 as the cell of the unlicensed band, and the combination identifier 010 corresponds to an activate instruction. Since the frequency band 15 is not originally used as the cell of the unlicensed band, it remains the same. The terminal device 1 can use the frequency band 16, but this is not illustrated because any control is not performed here in particular.

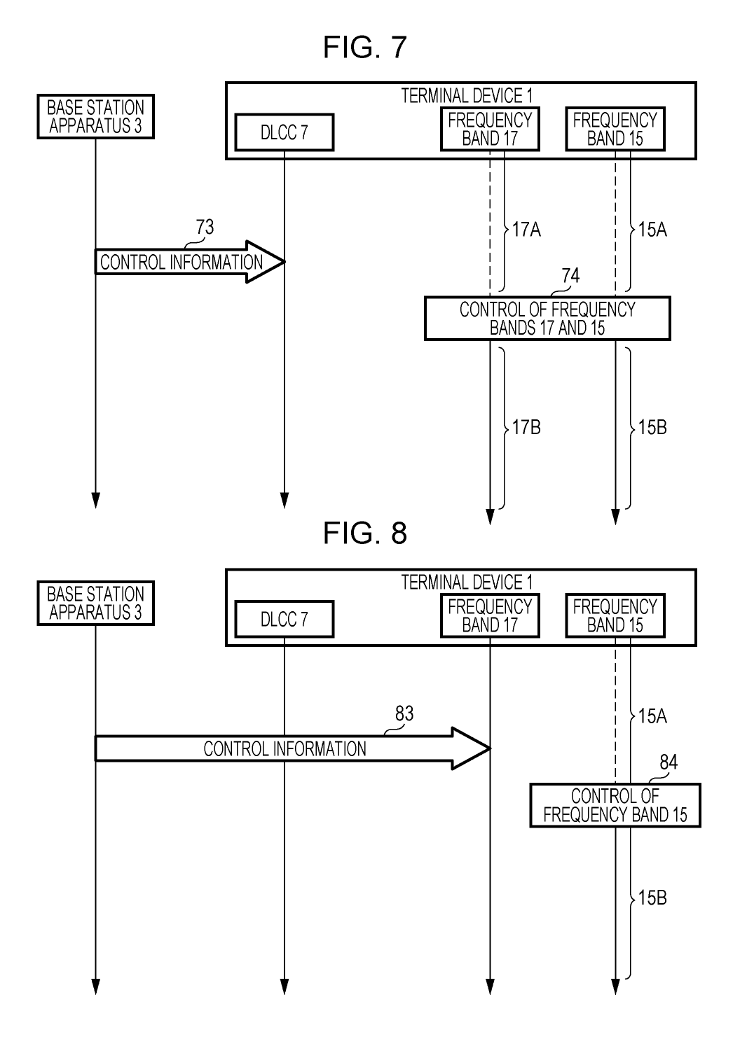

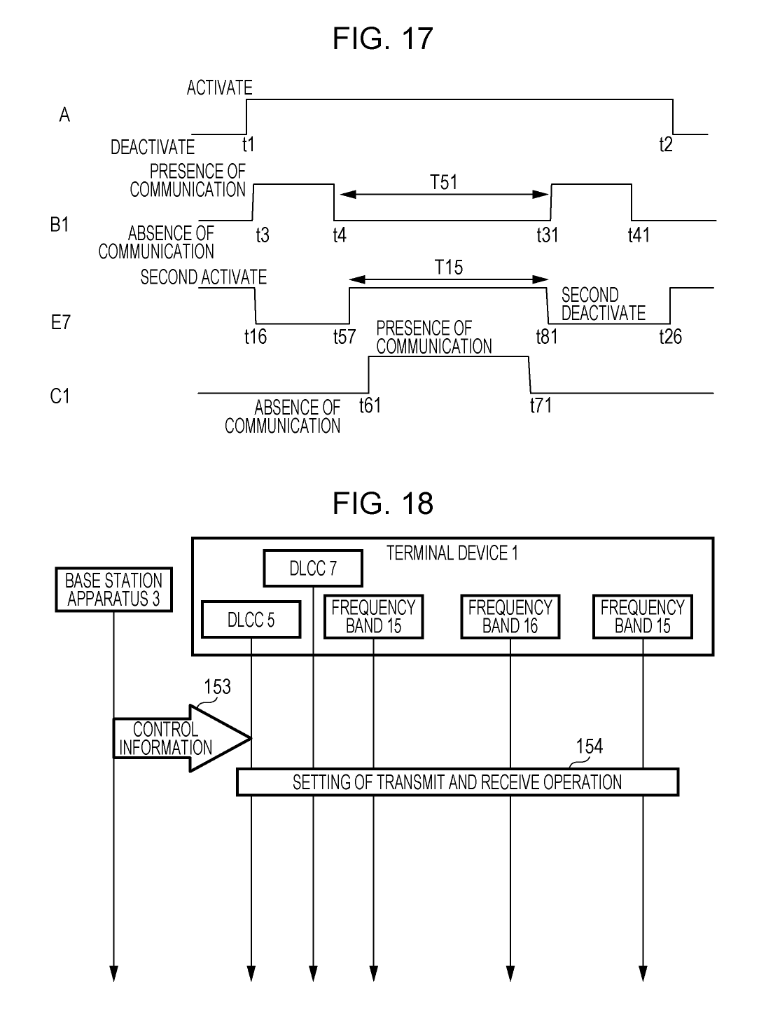

Another example of the present embodiment is illustrated in FIG. 7. The base station apparatus 3 notifies the terminal device 1 of the control information by using DLCC 7 (corresponding to an arrow 73 in FIG. 7). Here, not only the frequency band 17 but also the frequency band 15 are used as the cell of the unlicensed band. In this case, the control information includes a combination identifier 011 as the unlicense control information. The terminal device 1 controls the frequency band 17 and the frequency band 15 so as to be used as the cell of the unlicensed band in accordance with the control information (74 in FIG. 7). Before the radio resource control circuit unit 1011 executes the control (74 in FIG. 7) since the terminal device 1 (the reception circuit unit 105) receives the control information, the frequency bands 17 and 15 are not used as the cell of the unlicensed band (17A and 15A in FIG. 7), but they are used as the unlicensed band with this control (after this control). This corresponds to 17B and 18B in FIG. 7. In FIG. 17, in a state where the frequency bands 15 and 17 which can be used as the cells of the unlicensed band are not used as the cells of the unlicensed band, the control information of the unlicensed band (the combination identifier 011) is acquired, and the frequency bands 15 and 17 are started to be used (activated) as the cells of the unlicensed band. The control information may be an instruction to activate the frequency bands 15 and 17 as the cells of the unlicensed band, and the combination identifier 011 corresponds to an activate instruction. The terminal device 1 can use the frequency band 16, but this is not illustrated because any control is not performed here in particular.

Another example of the present embodiment is illustrated in FIG. 8. FIG. 6 and FIG. 7 are an example of a case where the cell of the unlicensed band is not set or used. On the other hand, here, a case where the cell of the unlicensed band is already used is illustrated. For example, in FIG. 8, the frequency band 17 is already used as the unlicensed band. In such a state, the notification of the control information is sent to the terminal device 1 not by using DLCC 5 or DLCC 7 which is the cell of the licensed band, but by using the DLCC of the frequency band 17 (corresponding to arrow 83 in FIG. 8). Here, a description will be given on a case where a new frequency band 15 is added as the cell of the unlicensed band. In this case, the control information includes a combination identifier 011 as unlicensed control information. Since the frequency band 17 is already used as the cell of the unlicensed band, if the terminal device 1 (the reception circuit unit 105) receives the control information, the radio resource control circuit unit 1011 controls the frequency band 15 so as to be used as the cell of the unlicensed band in accordance with the control information (84 in FIG. 8). The frequency band 15 is not used as the cell of the unlicensed band before this control (15A in FIG. 8), but the frequency band 15 is used as the unlicensed band with this control. This corresponds to 15B in FIG. 8. In FIG. 8, in a state where the frequency band 15 which can be used as the cell of the unlicensed band is not used as the cell of the unlicensed band, the control information of the unlicensed band (the combination identifier 011) is acquired, and the frequency band 15 is started to be used (activated) as the cell of the unlicensed band. The control information may be an instruction to activate the frequency band 15 as the cell of the unlicensed band, and the combination identifier 011 corresponds to an activate instruction. Since the terminal device 1 can use the frequency band 16, but this is not illustrated because any control is not performed here in particular.

In FIG. 8, the notification of the control information is sent by using the frequency band 17 which is used as the cell of the unlicensed band, but may be sent by using, for example, one of or both the cell 7 and the cell 5 which are the cells of the licensed band.

Further, the notification of the control information is sent to the terminal device 1 by using DLCC 7 in FIG. 6 or FIG. 7, but the notification may be sent by using DLCC 5 or both DLCC 5 and DLCC 7. Further, in FIG. 6 to FIG. 8, component carriers used in the information frequency band 17 and the frequency band 15 may be controlled so as to use the ULCC and DLCC, or may be controlled so as to use both DLCC and ULCC, or only DLCC, as in FIG. 5.

### Third Embodiment

The first notification method and the second notification method, and the first acquisition method and the second acquisition method corresponding thereto are described in the second embodiment, but a method of indicating that notified information is unlicensed band control information is described in the present embodiment.

The unlicensed band control information may be notified to the terminal device 1 together with other control information. It is necessary for the terminal device 1 to acquire the information notified from the base station apparatus 3 which is the unlicensed band control information by being distinguished from other control information. Alternatively, even if the notified information is only unlicensed band control information, it is necessary to know that it is only unlicensed band control information.

Whether or not the notified information is the unlicensed band control information may be explicitly notified or implicitly notified from the base station to the terminal device 1. For example, if the base station apparatus 3 and the terminal device 1 share and use the format to be dedicatedly used in the notification of unlicensed band control information, the base station apparatus 3 can inform easily the terminal device 1 of the information. For example, the terminal device 1 can easily determined that information notified, when the terminal device 1 detects that the used format is a dedicated format which is dedicatedly used in the unlicensed band control information, is unlicensed band control information.

Not only that there is a method of using a dedicated identifier. The terminal device 1 specifies control information addressed to its own station from PDCCH candidates by performing blind decoding using a specific identifier (for example, C-RNTI, SPS C-RNTI, or other identifiers) when detecting the control information addressed to its own station, and further specifies which function the control information is related to, when specifying the control information addressed to its own station.

For example, the base station apparatus 3 can notify the terminal device 1 of the control information about the cell of the unlicensed band, by defining and using Unlicensed band C-RNTI (U C-RNTI) which is an identifier (dedicated identifier) that is dedicated to the unlicensed band control information which is control information related to the cell of the unlicensed band.

To be more specific, the base station apparatus 3 (radio resource control circuit unit 3011) allocates the U C-RNTI which is a dedicated identifier used for the unlicensed band control information, to the terminal device 1. The base station apparatus 3 (radio resource control circuit unit 3011) disposes PDCCH that is scrambled using the U C-RNTI. The DLCC in which the PDCCH is disposed is the DLCC 7 which is DLCC of primary cells in the case of the first notification method, according to the second embodiment.

Here, the PDCCH may be disposed in the cell 5 which is the secondary cell. In a case where the cell of the unlicensed band is already used, the PDCCH may be disposed in any of the cells of the unlicensed band or the cells of a plurality of unlicensed bands.

In other words, the base station apparatus 3 may notify the terminal device 1 of the unlicensed band control information by using the cells of at least one licensed band (the first notification method may be executed). The base station apparatus 3 may notify the terminal device 1 of the unlicensed band control information by using the cells of at least one unlicensed band (the second notification method may be executed).

Further, the first notification method and the second notification method may be used in combination with each other. For example, in a case where the frequency band 17 is set as the cell of the unlicensed band in the first embodiment, the PDCCH may be disposed in the DLCC of the frequency band 17. Even in a case where there are cells of the existing unlicensed band, the PDCCH may be disposed in the DLCC 7 by the first notification method; and in a case of using, for example, the frequency band 17 as the cells of the unlicensed band, the PDCCH may be disposed in the DLCC of the frequency band 17. The PDCCH may be disposed by selectively using the first notification method and the second notification method.

Cells in which the information is disposed may be determined as appropriate, for example, depending on the amount of information to be notified by each cell. Alternatively, in a case of specifying or setting cells capable of using the dedicated identifiers, the dedicated identifiers may be disposed according to the setting.

When decting the PDCCH, the terminal device 1 (the decoding circuit unit 1051) performs blind decoding using the U C-RNTI, in addition to the specific identifier (for example, C-RNTI or SPS C-RNTI), and if it is successful in the descrambling by the U C-RNTI, it is possible to obtain the unlicensed band control information addressed to its own station. As described above, in a case where the base station apparatus 3 uses the first notification method using the DLCC 7, the first acquisition method may be executed by performing blind decoding on the DLCC 7; and in a case where the base station apparatus 3 uses the second notification method, the second acquisition method may be executed by performing blind decoding on the DLCC of the cell of the existing unlicensed band.

In a case where the base station apparatus 3 uses the first notification method, and the PDCCH is disposed in the DLCC of the secondary cell rather than the primary cell as described above, the first acquisition method may be executed by performing the blind decoding on the secondary cell. For example, the blind decoding may be performed on the DLCC 5, or the blind decoding may be performed on the DLCC of the frequency band 17. In a case it is unknown whether the base station apparatus 3 uses the first notification method or the second notification method, both the first acquisition method and the second acquisition method may be executed, by performing blind decoding on the DLCC of the frequency band 17, rather than the DLCC 7 or the DLCC 5. In other words, the first acquisition method and the second acquisition method may selectively be executed, or both ma be executed.

In the present embodiment, a description will be given on the use of a dedicated format or a dedicated identifier in order to inform the terminal device 1 of the unlicensed band control information. In particular, it is possible to notify the terminal device 1 of the unlicensed band control information by using an existing method, without using the second notification method according to the second embodiment.

For example, in a case where the base station apparatus 3 uses the second notification method, in other words, when the base station apparatus 3 notifies the terminal device 1 of the unlicensed band control information by using the cells of the existing unlicensed band, it is possible to notify the terminal device 1 of the unlicensed band control information by deliberately using the identifier which is not used in the cells of the unlicensed band.

Since the unlicensed band is not permitted to be used exclusively as described above, the base station apparatus 3 and the terminal device 1 cannot use the unlicensed band in communication over a long period of time. Thus, a function such as semi-static scheduling (Semi-Persistent Scheduling), which is expected to be used over a long period of time, is not appropriate for a function of the unlicensed band, and it is considered better not to use the function. Thus, the semi-static scheduling is not to be used. In this case, it is possible to assume that the SPS C-RNTI is not used as the identifier in the unlicensed band. In a case where the identifier which is not to be used is determined in advance, it is possible to notify of the unlicensed band control information by deliberately using the identifier.

Thus, in a case of notifying the terminal device 1 of the unlicensed band control information by using the cells of the existing unlicensed band, the terminal device 1 deliberately uses the SPS C-RNTI that is the identifier which is not used, and can determine that the PDCCH which has been scrambled using the SPS C-RNTI and which is disposed in the cells of the unlicensed band is not the control information of the semi-static scheduling and is the unlicensed band control information. In other words, since in the unlicensed band, the base station apparatus 3 transmits a PDCCH that has been scrambled with a SPS C-RNTI, and the terminal device 1 performs blind decoding using the SPS C-RNTI, it is possible to notify of the unlicensed band control information.

Incidentally, the identifier as described above is not limited to the SPS C-RNTI. For example, in a case where random access is not used in the unlicensed band, the identifier may be a RA C-RNTI allocated for random access, and besides this, if a T C-RNTI is not used, the identifier may be the T C-RNTI. The identifier may be a function, specification, or a mechanism which is not used in the unlicensed band which is in use.

If the unlicensed band control information is, for example, scheduling information for the cells of the unlicensed band, the communication resource allocation by the scheduling at this time is handled by the terminal device 1 as the dynamic scheduling rather than the semi-static scheduling. Since the PDCCH transmitted in unlicensed bands in this way is determined as unlicensed band cell control information, it becomes possible to perform dynamic scheduling in the unlicensed band, without defining and notifying a new U C-RNTI.

### Fourth Embodiment

The case of starting the use of the frequency bands of the unlicensed band as the cells of the unlicensed band is described in the second embodiment, but a case of stopping the use as the cells of the unlicensed band is described in the present embodiment. When the base station apparatus 3 instructs the terminal device 1 to control the frequency bands of the unlicensed band to the non-use state of not being used as the cells of the unlicensed band, the contents and meaning of the information or the message transmitted from the base station apparatus 3 to the terminal device 1 are already described in the first embodiment.

In the present embodiment, a description will be given on the assumption that the dedicated information (message) is used as the information or the instruction transmitted from the base station apparatus 3 to the terminal device 1. In other words, it is assumed that the second unlicensed band control is instructed by the dedicated information (message). Here, the dedicated information to be used is one bit of dedicated bit, but without being limited thereto, the dedicated bit may be at least one bit, as described in the first embodiment. Here, the instruction of the second unlicensed band control using the dedicated bit is not limited to this, and as described above, the instruction may be notified using 000 which is the combination identifier in FIG. 4 and FIG. 5, or it may be notified that all frequency bands are not used as the cells of the unlicensed band by using the frequency information.

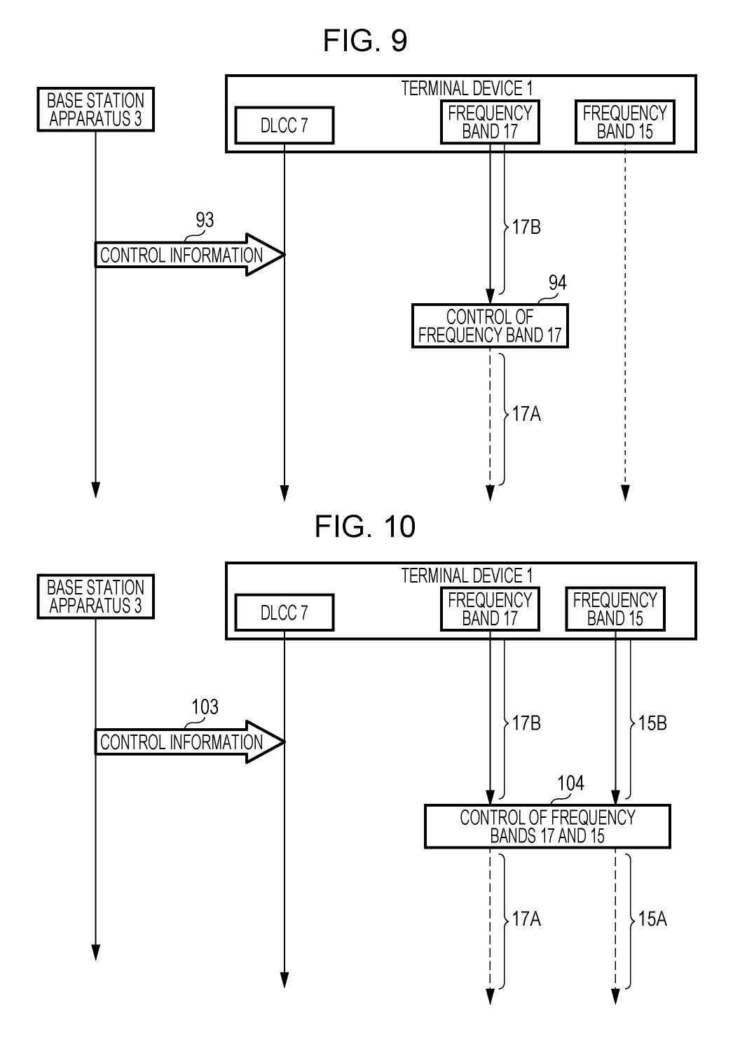

In FIG. 9, the base station apparatus 3 notifies the terminal device 1 of the control information by using DLCC 7 of the cell 7 which is a primary cell (corresponding to an arrow 93 in FIG. 9). Here, only the frequency band 17 is used as the cell of the unlicensed band. As the control information, 0 which is a dedicated bit is transmitted. If the terminal device 1 (the reception circuit unit 105) receives the control information, the radio resource control circuit unit 1011 controls the cells of all frequency bands so as not to be used as the cell of the unlicensed band in accordance with the control information. Here, since only the frequency band 17 is used as the unlicensed band, the radio resource control circuit unit 1011 controls only the frequency band 17 so as not to be used as the cell of the unlicensed band (94 in FIG. 9). The frequency band 17 is used as the cell of the unlicensed band before this control (17B in FIG. 9), but the frequency band 17 is not used as the unlicensed band with this control. This corresponds to 17A in FIG. 9. Since the frequency band 15 is not originally used as the cell of the unlicensed band, it remains the same. The terminal device 1 can use the frequency band 16, but this is not illustrated because any control is not performed here in particular. The notification of the control information is sent to the terminal device 1 by using the cell 7, but in a case where the secondary cell is used, the notification of the control information is sent to the terminal device 1 by using only the secondary cell, or using selectively or both the primary cell and the secondary cell.

Another example of the present embodiment is illustrated in FIG. 10. The base station apparatus 3 notifies the terminal device 1 of the control information by using DLCC 7 (corresponding to an arrow 103 in FIG. 10). Here, as described above, not only the frequency band 17 but also the frequency band 15 are used as the cell of the unlicensed band. In this case, the control information includes a dedicated bit 0. If the terminal device 1 (the reception circuit unit 105) receives the control information, the radio resource control circuit unit 1011 controls the frequency band 17 and the frequency band 15 so as not to be used as the cell of the unlicensed band in accordance with the control information (104 in FIG. 10). The frequency bands 17 and 15 are used as the cells of the unlicensed band before this control (17B and 15B in FIG. 10), but the frequency bands 17 and 15 are in a state of not being used as the unlicensed band with this control. This corresponds to 17A and 18A. The terminal device 1 can use the frequency band 16, but this is not illustrated because any control is not performed here in particular. The notification of the control information is sent to the terminal device 1 by using the cell 7, but in a case where the secondary cell is used, the notification may be sent to the terminal device 1 by using the secondary cell, or using both the primary cell and the secondary cell. The notification of the control information is sent to the terminal device 1 by using the cell 7, but in a case where the secondary cell is used, the notification may be sent to the terminal device 1 by using only the secondary cell, or using selectively or both the primary cell and the secondary cell.

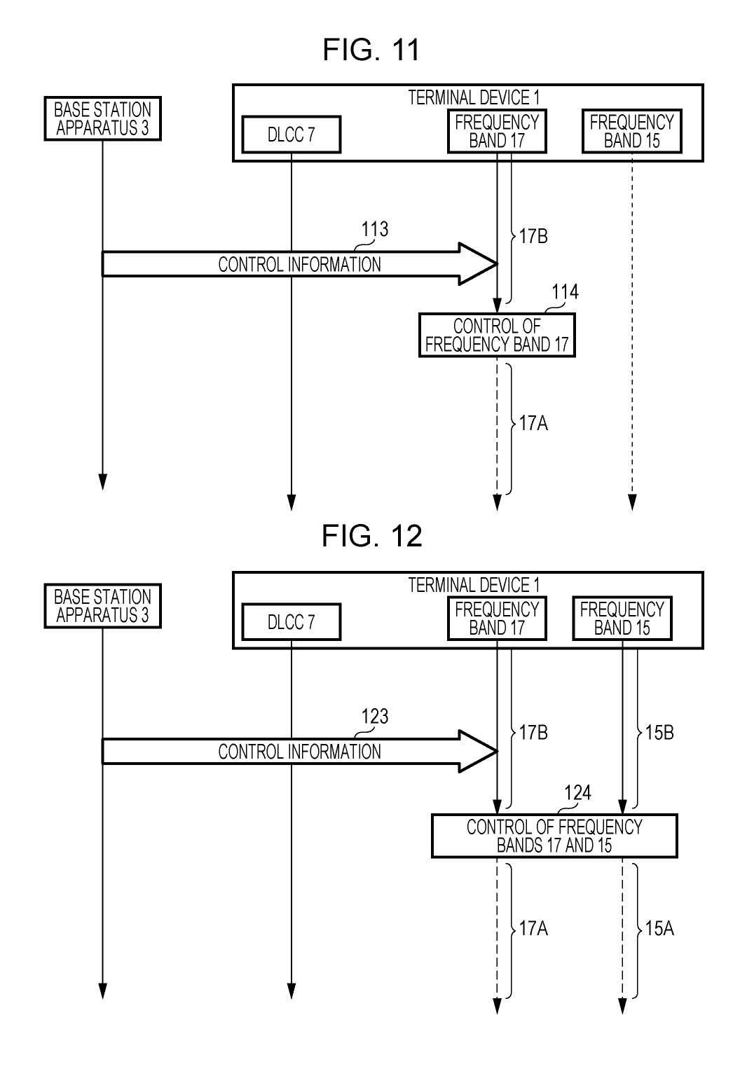

Another example of the present embodiment is illustrated in FIG. 11. FIG. 9 and FIG. 10 illustrate the case of using DLCC 7 which is the cell of the licensed band, but, here, the terminal device 1 is notified by using DLCC of the frequency band 17 which is already used as the cell of the unlicensed band (corresponding to an arrow 113 in FIG. 11). In this case, the control information which is notified to the terminal device 1 includes a dedicated bit 0 as the unlicense control information. The frequency band 17 is already used as the cell of the unlicensed band, and the frequency band 15 is used as the cell of the unlicensed band. If the terminal device 1 (the reception circuit unit 105) receives the control information, the radio resource control circuit unit 1011 controls the frequency band 17 so as not to be used as the cell of the unlicensed band in accordance with the control information (114 in FIG. 11). The frequency band 17 is used as the cell of the unlicensed band before this control (17B in FIG. 11), but the frequency band 17 is controlled so as not to be used as the unlicensed band with this control. This corresponds to 17A in FIG. 11. The terminal device 1 can use the frequency band 16, but this is not illustrated because any control is not performed here in particular.

Another example of the present embodiment is illustrated in FIG. 12. Here, the frequency bands 15 and 17 are already used as the cells of the unlicensed band. The terminal device 1 is notified by using DLCC of the frequency band 17 which is already used as the cell of the unlicensed band (corresponding to an arrow 123 in FIG. 12). In this case, the control information which is notified to the terminal device 1 includes a dedicated bit 0 as the unlicense control information. If the terminal device 1 (the reception circuit unit 105) receives the control information, the radio resource control circuit unit 1011 controls the frequency bands 15 and 17 so as not to be used as the cell of the unlicensed band in accordance with the control information (124 in FIG. 11). The frequency bands 15 and 17 are used as the cells of the unlicensed band before this control (15B and 17B in FIG. 12), but the frequency bands 15 and 17 are controlled so as not to be used as the unlicensed band with this control. This corresponds to 15A and 17A in FIG. 12. The terminal device 1 can use the frequency band 16, but this is not illustrated because any control is not performed here in particular. Here, the notification of the control information is sent to the terminal device 1 by using the cell 7, but the notification may be sent to the terminal device 1 by using the frequency band 15, or both. The notification of the control information is sent to the terminal device 1 by using the cell 7, but in a case where the secondary cell is used, the notification may be sent to the terminal device 1 by using only the secondary cell, or using selectively or both the primary cell and the secondary cell.

### Fifth Embodiment

Although the respective embodiments describe the setting and control method of the cell of the unlicensed band, but the operation of the terminal device 1 using the cell of the unlicensed band will be described in the present embodiment. Here, the terminal device 1 uses the cell 5 and the cell 7 as the cells of the licensed band, and all of the frequency bands 15, 16, and 17 that can be used as the cells of the unlicensed band. In addition, it is assumed that the access point 11 exists as in FIG. 1.

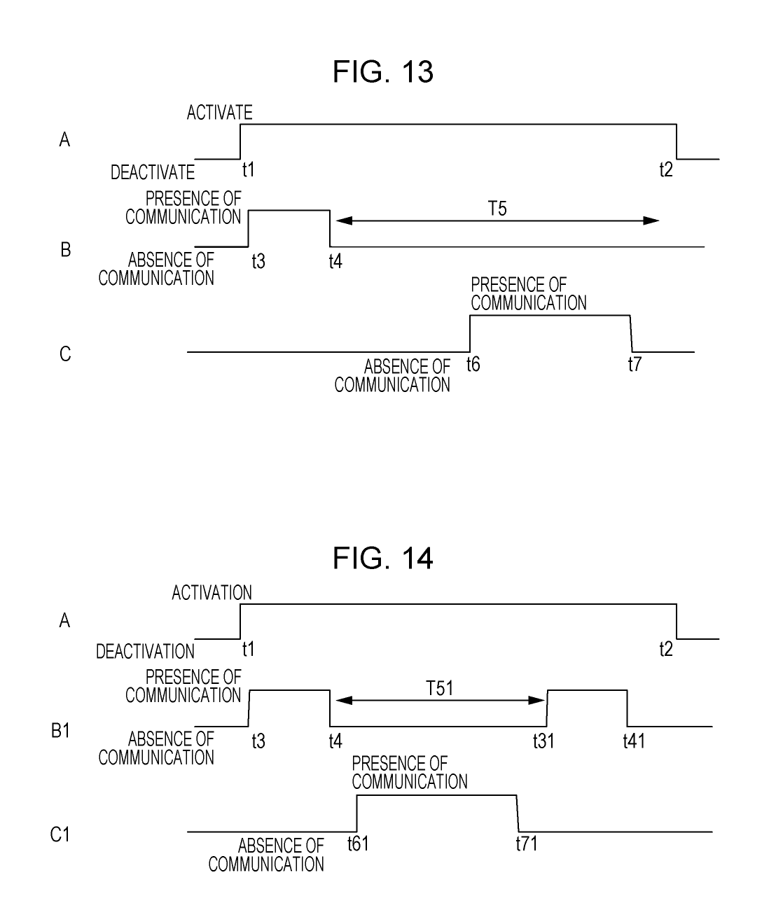

FIG. 13 is a transition diagram illustrating the state of a cell of each unlicensed band in the present embodiment. In FIG. 13, the horizontal direction is a temporal direction, and typically indicates the frequency band 15. A in FIG. 13 indicates the state of the cell of the unlicensed band. For example, the frequency band 15 is started to be used as the cell of the unlicensed band at time t1, and is controlled to a state of not being used as the cell of the unlicensed band at time t2. Here, a state of being used as the cell of the unlicensed band is described as a first state of being activated, a first activated state, or first activate. Starting the use as the cell of the unlicensed band is referred to as first activating. Hereinafter, unless otherwise stated or limited, these are respectively referred to as an activated state, an activated state, activate, or activating, by omitting “first”.

Further, a state of not being used as the cell of the unlicensed band is described as a first state of being deactivated, a first deactivated state, or simply first deactivate. Stopping the use as the cell of the unlicensed band is referred to as first deactivating. Hereinafter, unless otherwise stated or limited, these are respectively referred to as a deactivated state, a deactivated state, deactivate, or deactivating, by omitting “first”.

B in FIG. 13 actually illustrates whether or not communication resources for transmitting user data are allocated by the base station apparatus 3 and used in communication (the presence or absence of communication). As in B of FIG. 13, radio resources are scheduled and actual communication is started at time t3 and communication is ended at time t4 (hereinafter, communication with the base station apparatus 3 using the cells of the unlicensed band is referred to as first communication).

However, the frequency band 15 remains still activated as the cells of the unlicensed band even after t4. Thus, in a time domain T5, the frequency band 15 is in a state that is not used actually, while being activated and can be used for communication at any time. In other words, in the time domain T5, the frequency band 15 is in a state of being activated as the cell of the unlicensed band, but in which a part is not allocated as a communication resource.

Thus, the terminal device 1 can start communication with, for example, the access point 11, or other devices such as other personal computer or a printer, not illustrated, according to other specifications, for example, according to 802.11n, without using the frequency band 15 as the cells of the unlicensed band in the time domain IS (hereinafter, such communication different from the first communication is referred to as second communication). In FIG. 13, communication in accordance with 802.11n is started at time t6, and the communication in accordance with the 802.11n is ended at time t7.

FIG. 14 illustrates another example. A in FIG. 14 indicates whether or not the frequency band 15 is used as the unlicensed band, that is, whether or not it is activated similar to FIG. 13. B1 represents whether or not the frequency band 15 is used as the cell of the unlicensed band (whether or not the terminal device 1 communicates with the base station apparatus 3 using the frequency band 15), and C1 indicates whether or not the frequency band 15 is used as 802.11n.

In the time domain T51 of B1, despite being activated as the cell of the unlicensed band, the frequency band 15 is not used for communication. During time t61 to time t71 in C1, the terminal device 1 performs communication with, for example, the access point 11, or other devices such as a personal computer or a printer, according to 802.11n.

Further, in FIG. 13 and FIG. 14, it may be configured to notify the base station apparatus 3 of the start of communication (for example, using the cell 7 and the cell 5 which are the cells of the licensed band) which is different from the communication using the cells of the unlicensed band, or it may be configured to notify the base station of the end of communication other than the communication using the cells of the unlicensed band, when ending the communication.

In the communication as in FIG. 13 and FIG. 14, if the terminal device 1 easily starts the second communication, the base station apparatus 3 may not start properly the first communication when attempting to start the first communication in some cases. Therefore, the base station apparatus 3 can notify the terminal device 1 of information indicating whether or not the second communication is possible. The terminal device 1 acquires the information from the base station apparatus 3, can determine whether or not the second communication can be started based on the information, and starts or does not start the second communication, depending on the determination.

For example, when acquiring the information explicitly indicating that the second communication is permitted (information for permitting the second communication) from the base station apparatus 3, the terminal device 1 starts the second communication, as necessary. However, in a case where the terminal device 1 does not determine that the second communication is necessary, or determines that the second communication is unnecessary, even if the information for permitting the second communication is acquired from the base station apparatus 3, the second communication is not performed.

Conversely, even in a case where the terminal determines that the second communication is necessary, if the information for permitting the second communication is not acquired from the base station apparatus 3, the second communication is not started. Similarly, in a case where the base station apparatus 3 does not notify the terminal device 1 of the information for permitting the second communication, and instead thereof, information for prohibiting the second communication is acquired, the terminal device 1 does not start the second communication.

Conversely, in a case where the base station apparatus 3 does not notify the terminal device 1 of the information for prohibiting (not permitting) the second communication, and the terminal device 1 does not acquire the information for prohibiting the second communication from the base station apparatus 3, if the terminal device 1 determines that the second communication is necessary, it may be configured to start the second communication according to the determination.

In other words, the base station apparatus 3 can notify the terminal device 1 of permission or prohibition of the second communication, based on at least one of or both the information for permitting the second communication and the information for prohibiting the second communication, and thus the terminal device 1 can determine whether the second communication is prohibited or permitted.

Information used for determination whether or not second communication may be started may be information indicating directly in this manner, but the base station apparatus 3 indirectly can give an instruction to the terminal device 1. The instruction is given by using, for example, the information used for determination whether or not second communication can be started. As an example of the information used for determination whether or not second communication can be started, it is possible to use information indicting a threshold, which is notified from the base station apparatus 3 to the terminal device 1. The notification of the threshold may be individually notified to each terminal device, for example, may be individually notified by being included in the unlicensed band control information, but it may be notified by being included in broadcast information. For example, in a case where a certain threshold which is information notified from the base station apparatus 3 to the terminal device 1 is common in a system and is not change, it does not need to be notified.

The terminal device 1 compares the total accumulated amount of the communication resource which is allocated in at least one of or both the cells of the unlicensed band and the cells of the licensed band or the communication resource amount in unit time with the threshold, and in a case where the communication resource amount is below or above the threshold, the terminal device 1 may determine that the resources are likely to be allocated or unlikely to be allocated to the cells of the unlicensed band. The terminal device 1 may determine that the second communication is enabled or disabled.

Here, the terminal device 1 uses the communication resource to be allocated in order to determine whether or not second communication is possible, but can use other control information, or both the communication resource and other control information, without being limited thereto. As other control information, it is possible to use, for example, a modulation scheme, transmit power of the terminal device 1, communication quality, throughput, or the like, but the control information is not limited thereto, and in a case where such control information is used, the threshold may not be a single value, but may be a plurality of values.

Further, the terminal device 1 may independently make determination, without acquiring the information used for determination whether or not second communication can be started from the base station apparatus 3. For example, the terminal device 1 may independently make determination by using a communication resource, a modulation scheme, transmit power, or a throughput, which is allocated as described above.

Further, in the present embodiment, there is no distinction between the uplink and downlink in the communication between the base station apparatus 3 and the terminal device 1. In other words, a description has been made under the assumption that both uplink communication and downlink communication are performed. The present embodiment is not limited thereto, for example, the frequency band may have only downlink, in other words, it may be configured only with DLCC.

Further, in the above, the terminal device 1 makes two types of determination, upon starting the second communication. First, the terminal device 1 determines whether or not the second communication can be started (first determination), and determines whether to actually perform the second communication (second determination). In other words, determination as to whether or not the second communication is possible, which is made based on the information transmitted from the base station apparatus 3, can be the first determination, and determination whether or not the terminal device 1 is to perform the second communication regardless of the instruction from the base station apparatus 3 can be the second determination. As in the above embodiment, the second determination may be performed after the first determination, or the second communication may be performed based on only the second determination as in the following example.

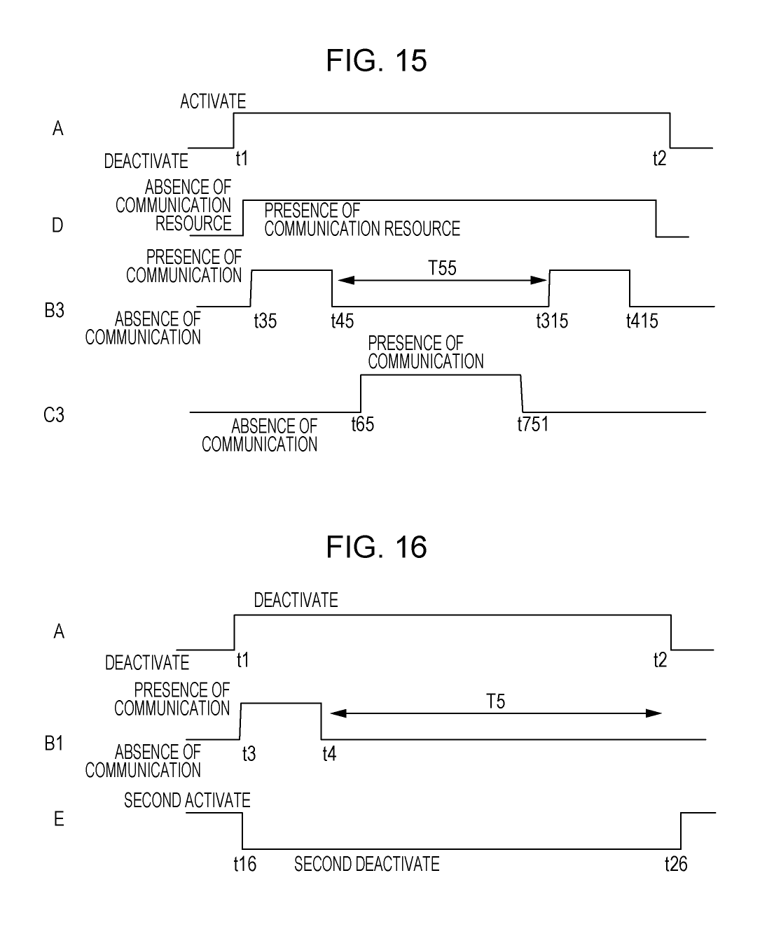

Another example is illustrated in FIG. 15. Similar to the above drawings in the present embodiment, A indicates whether or not the frequency band is activated as the cells of the unlicensed band. D indicates whether or not communication resources are allocated to the frequency band which is activated. B3 indicates whether or not the first communication is actually performed with the base station apparatus 3 by using the allocated communication resource, and C3 indicates whether or not the second communication is performed. In FIG. 15, there is a time domain T55 in which the first communication using the communication resource is not performed, regardless of the allocation of the communication resource as D. In the time domain T55, since the communication resource is originally allocated, second communication is performed by deliberately using the communication resource which is originally to be used for the first communication. This is largely different from the case of FIG. 14.

In the example of FIG. 15, originally, the terminal device 1 normally performs the first communication with the base station apparatus 3 by using the communication resource while the communication resource is allocated, but the terminal device 1 independently stores the communication with the base station apparatus 3 (t45), and instead thereof, starts the second communication (t65). The second communication may be performed with, for example, another terminal device (not illustrated) or a printer (not illustrated), and there is no particular limit. After the start of the second communication, the second communication is ended at t751. After the end of the second communication, the terminal device 1 starts again the first communication with the base station apparatus 3 (t315). The terminal device 1 may transmit the data to be transmitted during T55 to the base station, by using, for example, another frequency band which is used as the cell of the unlicensed band, and may transmit the data to the base station by using the cell of the licensed band. Alternatively, the data may be transmitted to the end only by using the frequency band 15.

Further, the above respective drawings focus on the usage (using for communication with the base station apparatus 3) of the frequency band 15 which is used as the cell of the unlicensed band, and the frequency band 15 is used as the unlicensed band for simplification of explanation, but a decription in a case of communicating with other devices according to, for example, the specification of 802.11n, is partially omitted. The use of the frequency band 15 which is the unlicensed band will be described more specifically.

FIG. 16 illustrates the use (for example, communication with other devices according to the specification of 802.11n) of the frequency band 15 of the unlicensed band in FIG. 13. Since A and B1 are the same as in FIG. 13, a description thereof will be omitted. E in FIG. 16 indicates whether or not the terminal device 1 can use the frequency band of the unlicensed band, according to for example, the specification of 802.11n. The frequency band 15 is used as the unlicensed band (for example, a state that can be used in communication according to the specification of 802.11n) until time t16, and is controlled to a state of not being used as the cell of the unlicensed band at time t26 (for example, a state in which communication according to the specification of 802.11n is not possible). Here, a state that can be used as the unlicensed band (for example, communication according to the specification of 802.11n) is described as a second activated state, a second activated state, or a second activate. Starting the use (for example, use in communication according to the specification of 802.11n) as the unlicensed band (setting to the second activated state) is referred to as second activating. Further, a state that cannot be used as the unlicensed band (for example, being used in communication according to the specification of 802.11n) is described as a second deactivated state, a second deactivated state, or simply a second deactivate. Similarly, setting to a state that cannot be used as the unlicensed band (for example, being not used in communication according to the specification of 802.11n) is referred to as second deactivating. In other words, in FIG. 16, the frequency band 15 is in the first deactivated state until time t1 and is in the second activated state until time t16, and the frequency band 15 is controlled to the first activated state at time t1 and to the second deactivated state at time t16 (first activation and second deactivation). Similarly, the frequency band 15 is controlled to the first deactivated state at time t2 and to the second activated state at time t26 (first deactivation and second activation). In other words, E indicates second activation or second deactivation. Here, t1 and t16 may be different times (t1≠t16), or the same time (t1=t16). Similarly, t2 and t26 may be different times (t2≠t26), or the same time (t2=t26). In a case where simultaneous control is difficult, they may be respective different times. In this case, if t1<t16, namely, the second deactivation is performed after the first activate, such that during the period from t1 to t16, the frequency band goes to the second activated state while being in a first activated state. If there is a problem with this control, it is set that t1>t16 and the first activation may be performed after the second deactivate. Similarly, with respect to t2 and t26, it is set that t2<t26 and the second activation is performed after the first deactivate.

Another example is illustrated in FIG. 17. FIG. 17 illustrates second activation and second deactivation of the frequency band 15 in FIG. 14. Since A, B1, and C1 in FIG. 17 are the same as in FIG. 14, a description thereof will be omitted. In FIG. 17, E7 indicates second activation or second deactivation, and indicates whether or not the terminal device 1 can use the frequency band of the unlicensed band, according to, for example, 802.11n specification. Similar to FIG. 16, the frequency band 15 is in a first deactivated state until time t1 and is in a second activated state until time t16, and the frequency band 15 is controlled to the first activated state at time t1, and to the second deactivated state at time t16.

Similarly, the frequency band 15 is controlled to the first deactivated state at time t2, and to the second activated state at time t26. If it is determined that the terminal device 1 does not communicate with the base station apparatus 3 by using the cell of the unlicensed band in the time domain T15 in FIG. 17, the frequency band 15 goes to the second activated state.

Although other various types of determination are possible as the determination in addition to the above, here, it is assumed that the terminal device 1 performs determination by using throughput (or communication quality). For example, the terminal device 1 achieves a better throughput by the first communication at first, for example, immediately after t3. However, in a case where the throughput (or the communication quality) is decreased immediately before t4, it is possible to switch communication to the second communication. During the communication by the second communication, if the throughput (or the communication quality) of the first communication is improved, the communication may be switched to the first communication.

Further, the communication destination of the second communication may also be the base station apparatus 3, another device, for example, a printer or another terminal device. In a case where the terminal device 1 determines that communication with another device is necessary by the second communication during the first communication, the first communication may be interrupted, and second communication with a different device other than the base station apparatus 3 may be performed.

Alternatively, even in a case where the frequency band of the unlicensed band, for example, the frequency band 15 is activated as the cell of the unlicensed band by the base station apparatus 3, or the communication resource for the first communication is allocated in the terminal device 1, the terminal device 1 determines to perform the second communication without performing the first communication, and may control so as to perform the second communication. For example, such a control is effective for a case where the communication with the base station apparatus 3 is higher in the communication cost is higher, and consumes more power.

Conversely, in a case where for example, the communication with the base station apparatus 3 is cheaper in communication cost, and consumes less power, without performing the second communication, it is possible to control so as to perform only the first communication for the communication with the base station apparatus 3.

In FIG. 17, second activation is performed at t57, and thereafter, the second communication is started at t61. Thereafter, if the second communication is ended, second deactivation is performed at t81, and the terminal device 1 starts again the first communication at t31. Thereafter, the frequency band is controlled to the first deactivated state at t2 as described above, and is controlled to the second activated state at t26. Such a control, in other words, starting the second communication in the first activated state and the second activated state by performing the second activation even in the first activated state, and returning only to the first activated state by performing the second deactivation after the second communication is not limited to FIG. 14, and can also be applied in FIG. 13 and FIG. 15. However, such control may be limited to the case where the terminal device 1 is in the first activated state and there is no problem in the second activated state.

The information used for determination whether or not second communication can be started may be, for example, the following information. For example, there is information indicating whether the scheduling information for the cell of the unlicensed band is acquired through the licensed band or the licensed band. In other words, the base station apparatus 3 can notify the terminal device 1 whether or not the second communication is possible, based on whether the base station apparatus 3 notifies the terminal device 1 of the scheduling information through the licensed band or the unlicensed band.

For example, the communication based on the scheduling information received from the base station apparatus 3 is started at t3. Here, in a case where the scheduling information is notified by using, for example, the cell of the licensed band, for example, if there is no scheduling information for the frequency band 15 which is the cell of the unlicensed band as in the time domain T51, as in FIG. 17, it is determined that second activation and the second communication are possible. In a case where the communication based on the scheduling information received from the base station apparatus 3 is started at t3, and here, the scheduling information is notified by using, for example, the cell of the unlicensed band, if there is no scheduling information for the frequency band 15 which is the cell of the unlicensed band as in the time domain T51, as in FIG. 17, it is determined that second activation and the second communication are possible.

Conversely, in FIG. 17, in a case where the first communication based on the scheduling information received from the base station apparatus 3 is started, and the scheduling information is notified by using, for example, the cell of the licensed band, if there is no scheduling information for the frequency band 15 which is the cell of the unlicensed band as in the time domain T51, as in FIG. 17, it is determined that second activation and the second communication are not possible. In a case where the communication based on the scheduling information received from the base station apparatus 3 is started at t3, and here, the scheduling information is notified by using, for example, the cell of the unlicensed band, for example, if there is no scheduling information for the frequency band 15 which is the cell of the unlicensed band as in the time domain T51, as in FIG. 17, it is determined that second activation and the second communication are possible.

In other words, the base station apparatus 3 can notify the terminal device 1 whether or not the second communication is possible, depending on whether the cell of the licensed band is used or the cell of the unlicensed band is used for the notification of the scheduling information for (the frequency band used as) the cell of the unlicensed band, and the terminal device 1 is able to recognize this.

Further, the scheduling information is described as an example of the control information for the unlicensed band in the above, but without being limited thereto, other control information may be used. For example, the determination may be made based on whether or not the licensed band is used for an unlicensed band activation instruction.

For example, in a case where the activation of the frequency band as the cells of the unlicensed band is performed by using the cells of the existing unlicensed band (in a case where the terminal device 1 receives an instruction to activate the cells of other unlicensed band by using the cells of the unlicensed band), the terminal device 1 determines that the second communication is possible or is permitted.

On the other hand, in a case where the activation of the frequency band as the cells of the unlicensed band is performed by using the cells of the licensed band (in a case where the terminal device 1 receives an instruction to activate the cells of other unlicensed band by using the cells of the licensed band), the terminal device 1 determines that the second communication is not permitted.

In other words, in a case where the cells of the unlicensed band are activated by using the cells of the unlicensed band, the terminal device 1 determines that the second communication is permitted. In a case where the cells of the unlicensed band are activated by using the cells of the licensed band, the terminal device 1 determines that the second communication is not permitted.

Conversely, in a case where the activation of the frequency band as the cells of the unlicensed band is performed by using the cells of the existing unlicensed band (in a case where the terminal device 1 receives an instruction to activate the cells of other unlicensed band by using the cells of the unlicensed band), the terminal device 1 determines that the second communication is not permitted.

On the other hand, in a case where the activation of the frequency band as the cells of the unlicensed band is performed by using the cells of the licensed band (in a case where the terminal device 1 receives an instruction to activate the cells of other unlicensed band by using the cells of the licensed band), the terminal device 1 determines that the second communication is permitted.

In other words, in a case where the cells of the licensed band are activated by using the cells of the unlicensed band, the terminal device 1 determines that the second communication is permitted. In a case where the cells of the unlicensed band are activated by using the cells of the unlicensed band, the terminal device 1 determines that the second communication is not permitted.

Such possibility determination for the second communication may be applied only to the cell of the unlicensed band, or may also be applied to other cells. Here, it is assumed that the unlicensed band 15 is already activated, if the frequency band which is the cell of the unlicensed band is activated by using the cell of the unlicensed band, the second communication is permitted; and if the frequency band is activated by using the cell of the licensed band, the second communication is not permitted.

For example, in a case where for example, the frequency band 16 is activated by using the frequency band 15 which is used as the cells of the unlicensed band, it may be determined that the second communication is permitted only in the frequency band 16, but it may be determined that the second communication is permitted in all frequency bands (frequency bands 15 and 16) which are in use.

On the other hand, in a case where for example, the frequency band 16 is activated by using the cell (for example, the cell 5) which is used as the cell of the licensed band, it may be determined that the second communication is not permitted only in the frequency band 16, but it may be determined that the second communication is not permitted in all frequency bands (frequency bands 15 and 16) which are in use.

The above example is focused on only whether the control information such as the licensed band control information is notified through the licensed band or unlicensed band. In the following example, a method is described in which the base station apparatus 3 notifies the terminal device 1 whether or not the second communication is permitted, depending on which frequency band or cell is used for the notification of the control information.

This example focuses on which frequency band is used for the notification of the scheduling information for the frequency band 15, in a state where the frequency band 15 is used as the cell of the unlicensed band as described above.

In a case where the scheduling information for the frequency band 15 is notified by using those other than the frequency band 15, it is indicated that the second communication is permitted; and in a case where the frequency band 15 itself is used, it is indicated that the second communication is not permitted. Here, those other than the frequency band 15 may be, for example, the cell 5 or the cell 7 of the licensed band, and in a case where those other than the frequency band 15 are already used as the cell of another unlicensed band (for example, the frequency band 16 or 17 is already used), those other than the frequency band 15 may be the frequency band 16 or 17 other than the frequency band 15.

Conversely, in a case where the scheduling information for the frequency band 15 is notified by using those other than the frequency band 15, it may be indicated that the second communication is not permitted; and in a case where the frequency band 15 itself is used, it may be indicated that the second communication is permitted. Here, those other than the frequency band 15 may be, for example, the cell 5 or the cell 7 of the licensed band, and in a case where those other than the frequency band 15 are already used as the cell of another unlicensed band (for example, the frequency band 16 or 17 is already used), those other than the frequency band 15 may be the frequency band 16 or 17 other than the frequency band 15.

### Sixth Embodiment

In the above respective embodiments, in order for the unlicensed band control information included in the control information to indicate whether the frequency band of the unlicensed band is used or not as the cell of the unlicensed band, information used for determination whether or not second communication may be started is included. In the present embodiment, a description will be given on the case of including other types of information, for example, scheduling information as the unlicensed band control information.

For example, a description is given on the case of FIG. 1. In FIG. 1, the cells 5 and 7 are used as the cells of the licensed band. In this state, it is assumed that the communication with those other than the base station apparatus 3 which is performed by the terminal device 1 using the frequency band of the unlicensed band as the cell of the unlicensed band is interrupted, and the communication with the base station apparatus 3 is performed by using as the cell of the unlicensed band. In this configuration, a method of notifying the scheduling information for the cell of the licensed band from the base station apparatus 3 to the terminal device 1 is classified into four methods.

A first scheduling information notification method is a method of notifying of the scheduling information for the cell of the licensed band by using the cell of the licensed band. For example, the scheduling information for the cell 5 may be notified by using the cell 5, or is notified by using a cell different from the cell 5, here, the cell 7. That is, notifying of the scheduling information for at least one licensed band by using the cell of at least one licensed band is the first scheduling information notification method.

On the other hand, a method of notifying of the scheduling information for the cells of the licensed bands of the cell 5 and the cell 7 by using the frequency band which is used as the cell of the unlicensed band is a second scheduling information notification method. In the second scheduling information notification method, there is no particular limit to a frequency band that is the cell of the unlicensed band through which the scheduling information for the cell of the licensed band is transmitted, and there is also no particular limit to the cell of the licensed band which is notified by using the cell of the unlicensed band. It is focused on notifying the scheduling information for the cell of the license band by using the cell of the unlicensed band. That is, notifying of the scheduling information for at least one licensed band by using the frequency band which is used as the cell of at least one unlicensed band is the second scheduling information notification method.

It is possible to notify of the scheduling information for the cell of the unlicensed band by using the cell of the licensed band. This is a third scheduling information notification method. Also in here, the relationship between the cell of the licensed band for notifying the schedule information and the unlicensed band to be notified is not particularly limited. For example, the scheduling information for the frequency band 15 which is the cell of the unlicensed band may be notified, the scheduling information for the frequency band 16 may be notified, and the scheduling information for the frequency band 17 may be notified by using the cell 7 which is the cell of the licensed band.

Further, the scheduling of the frequency bands which are used as the cells of a plurality of unlicensed bands may be notified by using the cell of a single licensed band, or may be notified by using the cells of a plurality of licensed bands. For example, it is possible to notify of the scheduling information for the frequency bands 15, 16, and 17 which are used as the unlicensed bands, by using the cell 5 and the cell 7. In other words, a method for notifying the scheduling information for the frequency band which is used as the cells of at least one unlicensed band by using the cell of at least one licensed band is a third scheduling information notification method.

A method for notifying the scheduling information for the cell of the unlicensed band by using the cell of the unlicensed band is a fourth scheduling information notification method. Here, for example, the scheduling information for the frequency band 17 may be notified by using the frequency band 17, or may be notified by using the cell of another unlicensed band.

For example, the scheduling information for the frequency band 16 may be notified by using the frequency band 15. Alternatively, the scheduling information for the frequency band 15 and the scheduling information for the frequency band 16 may be notified by using the frequency band 15, and the scheduling information for the frequency band 17 may be notified by using the frequency band 16, and the scheduling information for all frequency bands may be notified by using a single frequency band. In other words, a method of notifying the scheduling information for the frequency band which is used as the cell of at least one unlicensed band by using the frequency band which is used as the cell of at least one unlicensed band is the fourth scheduling information notification method. The above respective scheduling information notification methods can be performed independently or in combination with each other.

One example is illustrated in FIG. 18. FIG. 18 illustrates a case where the first scheduling information notification method and the third scheduling information notification method are executed. Here, the base station apparatus 3 notifies the terminal device 1 of a piece of control information, by including the licensed band control information including the scheduling information allocated to the cell of the licensed band and the unlicensed band control information including the scheduling information allocated to the cell of the unlicensed band in the control information.

Incidentally, the licensed band control information and the unlicensed band control information may be included in one piece of control information and notified at a time, may respectively be included in separate pieces of control information and notified separately, or may respectively be included in separate pieces of control information and notified to the terminal device 1 at a time.

The base station apparatus 3 notifies of control information including the scheduling information for the cells of the licensed band and the scheduling information for the cells of the unlicensed band. The notification is sent using the cell 5 which is the cell of the licensed band (an arrow 153 in FIG. 18). The terminal device 1 receives the control information, extracts the scheduling information, and performs setting of the transmission and reception operation in each cell and frequency band in accordance with the scheduling information (154 in FIG. 18).

In FIG. 18, the cell 5 is used in execution of a notification method of scheduling for each cell, but the cell 7 may be used. For example, in a case of using the cell 5 as a primary cell (using the cell 7 as a secondary cell), the primary cell may be used, or the cell 7 which is the secondary cell may be used instead of the cell 5 or in combination with the cell 5, in execution of the first scheduling information notification method and the third scheduling information notification method.

For example, in order to reduce the processing load of the terminal device 1, in particular, in order to reduce the processing relating to blind decoding which is performed by the terminal device 1, a specific single cell may be used. Especially, since the blind decoding of the primary cell is necessarily performed, a configuration of using only the primary cell is the most efficient. However, since the control information is not only scheduling information, in a case where using the primary cell is not appropriate, such as a case where there is a large number of control information to be notified, it is desirable to use the secondary cell.

For example, the scheduling information for the cell of the unlicensed band may be notified using only the secondary cell. In order to provide flexibility to the notification of the scheduling information, it is most desirable to use selectively or in combination with a plurality of cells for the notification of the scheduling information. Specifically, which cell to be used can be determined by the base station apparatus 3, with consideration of the amount of control information to be notified, or the property of control information other than the scheduling information, as to whether notification can be sent at the same time with the scheduling information. Further, the determination may be made based on the communication quality of each cell and the transmit power used for each cell.

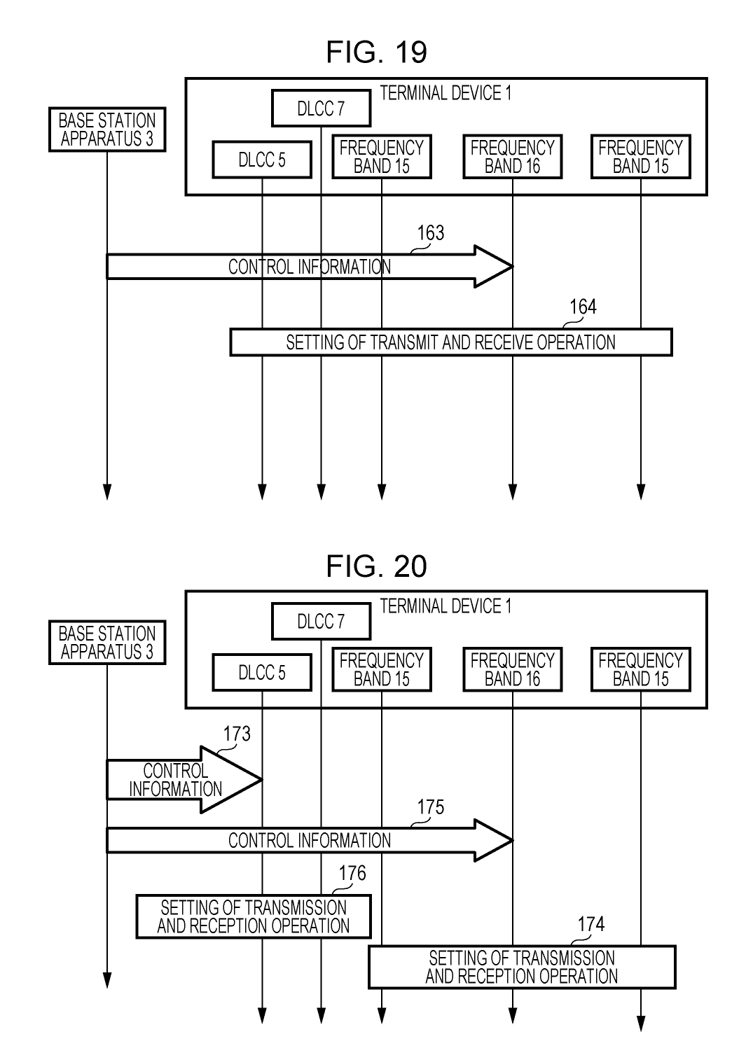

Another example is illustrated in FIG. 19. FIG. 19 illustrates a case where the second scheduling information notification method and the fourth scheduling information notification method are executed at the same time. Here, the base station apparatus 3 notifies the terminal device 1 of a piece of control information, by including the licensed band control information including the scheduling information allocated to the cell of the licensed band and the unlicensed band control information including the scheduling information allocated to the cell of the unlicensed band in the control information.

The base station apparatus 3 notifies of control information including the scheduling information for the cells of the licensed band and the scheduling information for the cells of the unlicensed band. The notification is sent using the frequency band 16 which is used as the cell of the unlicensed band (an arrow 163 in FIG. 19).

The terminal device 1 receives the control information, extracts the scheduling information, and performs setting of the transmission and reception operation in each cell and frequency band in accordance with the scheduling information (164 in FIG. 19). Further, in FIG. 19, the frequency band 16 is used as the cell of the unlicensed band in execution of a notification method of scheduling for each cell, but the frequency band 15 or the frequency band 17 may be used, other frequency band may also be used in combination therewith, or all frequency bands may be used.

In other words, it is possible to use the cells of at least one unlicensed band for the notification of scheduling information using the cells of the unlicensed band. Alternatively, it is possible to use the cells of at least one unlicensed band for the notification of the second scheduling information or the fourth scheduling information. For example, the frequency band 15 is used in the second scheduling information notification method, but the fourth scheduling information notification method may be configured to use the frequency band 16.

In the selective use, for example, in order to reduce the processing of the terminal device 1, in particular, in order to reduce the processing on the blind decoding that the terminal device 1 executes, the number of frequency bands to be used may be limited to in particular one. For example, the notification of the scheduling information may be sent using only the frequency band 16. In order to provide flexibility to the notification of the scheduling information, it is most desirable to use selectively or in combination with a plurality of frequency bands for the notification of the scheduling information.

For example, it can be determined by the base station apparatus 3 with consideration of the property of control information other than the scheduling information such as the amount of control information to be notified, or whether it can be notified at the same time with the scheduling information. Further, it may be determined based on the communication quality of each cell and the transmit power used for each cell. In other words, in FIG. 19, in a case where the frequency band 16 is used, but the communication quality of the frequency band 16 is deteriorated, a configuration to substitute the frequency band 15 or 17, in notification of the scheduling information is most desirable in order to maintain and secure stable communication.

Another example is illustrated in FIG. 20. FIG. 20 illustrates a case where the first scheduling information notification method and the third scheduling information notification method are separately executed. Here, the base station apparatus 3 separately notifies the terminal device 1 of respective pieces of control information, by including the licensed band control information including the scheduling information allocated to the cell of the licensed band and the unlicensed band control information including the scheduling information allocated to the cell of the unlicensed band in the respective pieces of control information.

The base station apparatus 3 notifies of control information including the scheduling information for the cells of the licensed band (an arrow 173 in FIG. 20). The base station apparatus 3 notifies of control information including the scheduling information for the cells of the unlicensed band (an arrow 175 in FIG. 20). The terminal device 1 receives the control information, extracts the scheduling information, and performs setting of the transmission and reception operation using the cells of the licensed band in accordance with the scheduling information (176 in FIG. 20). The terminal device 1 extracts the scheduling information for the cells of the unlicensed band after receiving the control information, and performs setting of the transmission and reception operation using the frequency band which is used as the cells of the unlicensed band in accordance with the scheduling information (174 in FIG. 20).

Further, although the cell 5 is used in execution of a notification method of scheduling for each cell in FIG. 20, similar to the explanation in FIG. 19, the cell of the licensed band to be used can be limited to a specific cell and can be properly used.

Although the frequency band 16 is used as the cell of the unlicensed band to be used in the notification of the scheduling information, similar to the explanation in FIG. 20, the cell of the licensed band to be used can be limited to a specific cell, and the specific cell and a plurality of other cells can be properly used.

Here, the first scheduling information notification method to the fourth scheduling information notification method are introduced, and it is preferable that all of them are available, but without being limited thereto, for example, the following control or configuration may be possible. For example, the first scheduling information notification method is available for the notification method of scheduling information for the cell of the license band, and it may be configured to use selectively or both the third scheduling information notification method and the fourth scheduling information notification method for the frequency band which is used as the cell of the unlicensed band. For example, this configuration is available for a case of executing the fifth embodiment, in particular, a case where the terminal device 1 independently starts the second communication, and the base station apparatus 3 starts communication using the cell of the unlicensed band with the terminal device 1 while the base station apparatus 3 does not recognize that the terminal device 1 starts the second communication.

A case is considered in which the base station apparatus 3 initiates communication by using the frequency band 15 while the terminal device 1 is initiating second communication with another device (for example, a printer), by using for example, the frequency band 15. In a case where the base station apparatus 3 executes the second scheduling information notification method by using the frequency band 15, the base station apparatus 3 notifies the terminal device 1 of control information including scheduling information on the licensed band by using the frequency band 15.

However, the terminal device 1 is communicating with another device by using the frequency band 15, and cannot successfully receive the control information notified from the base station apparatus 3. If the control information cannot be received, it could become a state where it is not possible to acquire the scheduling information necessary for the cell of the licensed band or another control information, it is not possible to acquire the scheduling information for the licensed band in the worst case, it is not possible to acquire the control information of the licensed band, and it is not possible to control and use the cell of the licensed band. Here, examples of the state where the cell cannot be controlled and used include a communication cut-off state, a state where a communication failure occurs, a Radio Link Failure state, or a state where secure communication cannot be maintained or secured.

In the same way, there is a case where the control information cannot be received even when the control information for the cell of the unlicensed band is notified by using the cell of the unlicensed band. Thus, notification of the control information of the licensed band without using the cell of the unlicensed band, in other words, notification of the control information of the licensed band only by using the cell of the licensed band is preferable to secure stable communication, and prevents the cut-off of the communiation between the base station apparatus 3 and the terminal device 1 so as to enable satable communication.

This configuration is not limited to the case of executing the fifth embodiment. For example, on its nature, the unlicensed band has an advantage in that an unspecified number of users freely use, and has a side effect in that the possibility of communication being unstable due to immoral use, the use of an incomplete device, or the use of a device without considering the specification is higher as compared to the licensed bands. Thus, the base station apparatus 3 may not notify the terminal device 1 of key information that can cause the cutoff of communication between the terminal device 1 and the base station or that can affect the communication, that is, the control information, by using the cells of the unlicensed band.

In particular, it is more desirable that the control information used in the cell of the licensed band is notified to the terminal device 1 using the cell of the stable licensed band. On the other hand, the control information of the cell of the unlicensed band may be notified using the cell of the unlicensed band. Even in a case where a failure occurs in the communication using the unlicensed band as described above and the terminal device 1 cannot successfully receive the control information of the unlicensed band, in a worst case, only the communication using the unlicensed band is cut off and the communication between the base station apparatus 3 and the terminal device 1 is not necessarily cut off, such that it does not become a big problem. On the other hand, in a case where the communication using the unlicensed band is often unstable, the control information of the unlicensed band may also be notified using the licensed band. However, in a case where the safe use of the unlicensed band is secured depending on the communication environment (for example, in a case where it has been found that the communication failure in the unlicensed band is unlikely to occur), the control information may be notified by the fourth scheduling information notification method.

It is desirable to combine the first to fourth scheduling information notification methods because it provides a more flexible mechanism for the notification of the scheduling information. Furthermore, it is more desirable that the base station apparatus 3 determines whether a communication failure occurs in the communication using the unlicensed band, and selectively uses the first to fourth scheduling information notification methods. Conversely, in a case where there is no means of determining whether a communication failure occurs in communication using the unlicensed band or the determination is not performed in terms of cost, it may be configured to use only the first scheduling information notification method and the third scheduling information notification method, or to use the first scheduling information notification method, the third scheduling information notification method, and the fourth scheduling information notification method.

Incidentally, a portion the terminal device 1 and the base station apparatus 3 in the embodiments described above may be implemented by a computer. In that case, they may be implemented by recording a program for implementing the control functions in a computer readable recording medium, and reading the program recorded in the recording medium into a computer system so as to be executed. Note that the term “computer system” may be a computer system that is built in the terminal device 1 or the base station apparatus 3, and is intended to include an OS and hardware such as peripheral devices.

In addition, the “computer-readable recording medium” refers to a flexible disk, a magneto-optical disk, a ROM, a portable medium such as a CD-ROM, or a storage device such as a hard disk built in a computer system. Furthermore, the “computer readable recording medium” may include those retaining programs dynamically for short time, such as a communication line in a case of transmitting programs through a network such as the Internet or a communication line such as a telephone line, and those retaining programs for a certain time such as a volatile memory inside a computer system which is a server or a client in this case. Further, the program may also be those for implementing a portion of the functions described above, or those for implementing the functions described above in combination with a program which is previously recorded in a computer system.

In addition, a portion or all of the terminal device 1 and the base station apparatus 3 in the embodiments described above may be implemented as an LSI which is an integrated circuit. The respective functional blocks of the terminal device 1 and the base station apparatus 3 may be formed into individual chips, and a portion or all thereof may be integrated and formed into a chip. Further, a method of manufacturing an integrated circuit may be implemented with a dedicated circuit or a general-purpose processor, without being limited to the LSI. Further, in a case where a technique of manufacturing an integrated circuit as an alternative LSI appears with the progress of a semiconductor technique, it is also possible to use an integrated circuit using this technique.

An embodiment of the present invention has been described in detail with reference to the drawings above, but the specific structure is not limited to those described above, and various design modifications are possible within the scope without departing from the gist of the present invention.

It should be noted that the present international application is intended to claim priority based on Japanese Patent Application No. 2014-089957 filed on Apr. 24, 2014, and the entire contents of Japanese Patent Application No. 2014-089957 is incorporated in the international application.

### REFERENCE SIGNS LIST

1 (1A, 1B, 1C) MOBILE STATION APPARATUS
3 BASE STATION APPARATUS
5 CELL
7 CELL
11 ACCESS POINT
15 FREQUENCY BAND
16 FREQUENCY BAND
17 FREQUENCY BAND
101 HIGHER LAYER PROCESSING CIRCUIT UNIT
103 CONTROL CIRCUIT UNIT
105 RECEPTION CIRCUIT UNIT
107 TRANSMISSION CIRCUIT UNIT
109 TRANSMIT/RECEIVE ANTENNA
301 HIGHER LAYER PROCESSING CIRCUIT UNIT
303 CONTROL CIRCUIT UNIT
305 RECEPTION CIRCUIT UNIT
307 TRANSMISSION CIRCUIT UNIT
309 TRANSMIT/RECEIVE ANTENNA
1011 RADIO RESOURCE CONTROL CIRCUIT UNIT
1051 DECODING CIRCUIT UNIT
1053 DEMODULATION CIRCUIT UNIT
1055 DEMULTIPLEXING CIRCUIT UNIT
1057 WIRELESS RECEPTION CIRCUIT UNIT
1071 CODING CIRCUIT UNIT
1073 MODULATION CIRCUIT UNIT
1075 MULTIPLEXING CIRCUIT UNIT
1077 WIRELESS TRANSMISSION CIRCUIT UNIT
3011 RADIO RESOURCE CONTROL CIRCUIT UNIT
3051 DECODING CIRCUIT UNIT
3053 DEMODULATION CIRCUIT UNIT
3055 DEMULTIPLEXING CIRCUIT UNIT
3057 WIRELESS RECEPTION CIRCUIT UNIT
3071 CODING CIRCUIT UNIT
3073 MODULATION CIRCUIT UNIT
3075 MULTIPLEXING CIRCUIT UNIT
3077 WIRELESS TRANSMISSION CIRCUIT UNIT

1: A base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used,
wherein the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

2: The base station apparatus according to claim 1,
wherein the control information includes an activate instruction.

3: The base station apparatus according to claim 1,
wherein when notifying the terminal device of the control information by using the frequency band that cannot be exclusively used, the base station apparatus notifies the terminal device of the control information by using an identifier that is used for a function that is used for the frequency band that can be exclusively used and is not used for the frequency band that cannot be exclusively used.

4: The base station apparatus according to claim 3,
wherein the function that is used for the frequency band that can be exclusively used and is not used for the frequency band that cannot be exclusively used is semi-static scheduling.

5: The base station apparatus according to claim 4,
wherein the identifier is SPS C-RNTI.

6: A processing method by a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used,
wherein the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

7: A terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used,
wherein the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.

8: A processing method by a terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used,
wherein the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.

9: A processing apparatus which is mounted to a base station apparatus capable of performing communication with a terminal device, by using a frequency band that can be exclusively used and a frequency band that cannot be exclusively used, by applying a communication scheme, which is applied to the frequency band that can be exclusively used, to the frequency band that cannot be exclusively used,
wherein the base station apparatus instructs the terminal device to perform the communication with the base station apparatus by applying the communication scheme to the frequency band that cannot be exclusively used, by notifying the terminal device of control information necessary for control so as to use the frequency band that cannot be exclusively used in the communication with the terminal device to which the communication scheme is applied, in a state where the frequency band that cannot be exclusively used is not used in the communication with the terminal device to which the communication scheme is applied.

10: A processing apparatus which is mounted to a terminal device capable of performing communication with a base station apparatus, by using a frequency band that can be exclusively used and a frequency band that cannot be exclusively used, by applying a communication scheme, which is applied to the frequency band that can be exclusively used, to the frequency band that cannot be exclusively used,
wherein the terminal device acquires an instruction for communication with the base station apparatus to which the communication scheme is applied to the frequency band that cannot be exclusively used, from the base station apparatus, by receiving control information necessary for control so as to use the frequency band that cannot be exclusively used in the communication with the base station apparatus to which the communication scheme is applied, from the base station apparatus, in a state where the frequency band that cannot be exclusively used is not used in the communication with the terminal device to which the communication scheme is applied.
